(19) United States
(12) Patent Application Publication
(10) Pub. No.: US 2006/0050946 A1
(43) Pub. Date: Mar. 9, 2006

(54) Computer-assisted cell analysis

(76) Inventors: Timothy J. Mitchison, Brookline, MA (US); Steven J. Altschuler, Cambridge, MA (US); Yan Feng, Andover, MA (US); Thomas Mayer, Munchen (DE); Zachary Edward Perlman, Boston, MA (US); Michael D. Slack, La Mesa, CA (US); Lani Wu, Cambridge, MA (US)

Correspondence Address: CHOATE, HALL & STEWART/HARVARD UNIVERSITY, TWO INTERNATIONAL PLACE, BOSTON, MA, 02110, US

(21) Appl. No.: 10/435,827

(22) Filed: May 12, 2003

Related U.S. Application Data
(60) Provisional application No. 60/379,296, filed on May 10, 2002.

(51) Int. Cl. G06K 9/00

(52) U.S. Cl. 382/133

(57) ABSTRACT

The present invention provides methods and systems for automated morphological analysis of cells. The inventive methods are particularly useful in the rapid analysis of cells required in a biological screen. Agents which cause a particular phenotype in the cells can be identified using the inventive quantitative morphometric analysis of cells. The data gathered using the inventive method can also be quantified and analyzed later for various trends and classifications. Characteristics of cells which can be determined using this method include number of nuclei, size of cell, size of nuclei, number of the centrosomes, shape of cells, size of centrosomes, perimeter of nucleus, shape of nucleus, pattern of staining, and degree of staining.

### RELATED APPLICATIONS

The present application claims priority to co-pending provisional application, U.S. Ser. No. 60/379,296, entitled “Computer-Assisted Cell Analysis”, filed May 10, 2002, the entire contents of which is incorporated herein by reference.

### BACKGROUND OF THE INVENTION

The impetus to design better screens for identifying chemical compounds with a desired biological activity has been heightened over the past decade with the advent of combinatorial chemistry. Organic chemists are now able to produce thousands to millions of compounds in parallel while achieving a high degree of chemical diversity. These new compounds must then be assayed or screened to identify compounds with a particular activity. Typically, a library of compounds is put through one assay at a time to look for a particular activity with most of the compounds not having the desired activity being assayed for.

Many of these screens and assays include exposing cells to a chemical compound and observing the effect of the compound on the cell. The exposure to the chemical compound may lead to inhibition of growth, to proliferation, to cell death, etc. resulting in the determination of concentrations at which 50% growth inhibition occurs, total growth inhibition occurs, and 50% lethality occurs. However, the determination of these few data points for a particular compound at a particular concentration is labor intensive and much data is lost by focusing on just certain aspects of the cells being cultured and exposed to the chemical compound.

In order to study the phenotype of cells, transcriptional profiling has been developed whereby the mRNAs being produced in a cell or culture of cells are analyzed to determine which genes have been turned on or off relative to a control. However, although transciptional profiling is powerful in analysing the transcription of a variety of genes, it only looks at the levels of transcription of genes and not at cell as a whole (i.e., the cell's phenotype).

### SUMMARY OF THE INVENTION

The present invention stems from the recognition that many biological screens, which use cytological analysis, in drug development, pathology, cell biology, and genomics require the microscopic analysis of cell samples. This work is usually carried out by a trained human microscope operator who laboriously looks at plates or wells of cells to find the cells with the desired phenotype. Because this type of work requires a trained human operator, it is very costly and time-consuming, and it is subject to human error especially when the operator becomes fatigued after looking at many samples. Also, with a human operator the results are not readily quantifiable and are usually limited to a handful of easily observable characteristics of the cells, and the data analysis may be limited to a scoring system designed for a particular experiment at the very beginning of the experiment. If later different aspects of the cells are to be analyzed or a different scoring system is to be used, the work must be repeated from the beginning.

The present invention provides methods and systems for automating the analysis of cells. The methods can be used to describe the physiological state of cells based on the automated collection of data from image processing software and statistical analysis of this data. One of the advantages of this method is that the data is broad, computable, and different than the data collected from transcriptional profiling experiments. In certain embodiments, the inventive method is a phenotype-based screening method for quantitative morphometric analysis of cells used to describe and quantitate the mechanism and specificity of drugs or drug candidates. An image of the cells is analyzed by a computer running image processing software designed to determine the various states, morphologies, appearances, characteristics, staining patterns, and/or conditions of the cells in the image. The aspects of the cells in the image to be analyzed include number of cells in the image, pixel area of each cell, perimeter of each cell, volume of each cell, ellipticity of each cell, shape of each cell, number of nuclei per cell, pixel area of each nucleus, perimeter of each nucleus, volume of each nucleus, shape of each nucleus, pixel area of nucleus, degree of staining for nucleic acid in each nucleus, number of centromeres per cell, average cross-sectional area of cells, morphology, eccentricity, degree of staining for a cytoplasmic protein, degree of staining for a nuclear protein, patter of staining, etc. These aspects may be quantified and used to determine the physiological or biochemical status of the cells imaged (e.g., what phase of the cell cycle the cells are in, whether the cells are starved, whether the cells are dividing, whether the cells are dieing, whether the cells are differentiating, whether the cells are undergoing apoptosis, whether protein synthesis has been inhibited, whether DNA synthesis has been inhibited, whether transcription has been inhibited). In certain embodiments, the cells are not labeled or modified before imaging, and in other embodiments, the cells may be fixed and/or labeled for various cellular organelles, nucleic acids such as DNA and RNA, protein, specific proteins, etc. Any type of cells may be used in the present invention (e.g., cells derived from laboratory cell lines, cells from a biopsy, cells derived from any species, bacterial cells, human cells, yeast cells, mammalian cells, etc.) In certain embodiments, the genomes of the cells have not been altered.

In a preferred aspect, the computer analysis of cell samples is used in biological screens where hundred to thousands of cell samples are to be analysed. This analysis is particularly useful in analyzing arrays of cells in which the cells in each well or plate have been treated with a particular agent (e.g., drugs, chemical compounds, small molecules, peptides, proteins, biological molecules, polynucleotides, anti-sense agents). The method is particularly useful in the field of high throughput screening. By analyzing the cells for various characteristics such as morphology, number of nuclei, number of centromeres, cell shape, volume of cell, volume of nuclei, etc. using a computer running the visual analysis software, one can screen a vast number of agents fairly quickly to identify those with a particular biological activity. For example, using this method one could identify agents that would be useful as anti-neoplastic agents by searching for agents that decrease the number of cells in the microscopic field, decrease the number of nuclei, and/or decrease the number of centromeres, that is searching for a microscopic field of cells that are not undergoing mitosis. In another example, one may screen known compounds such as an antibiotic (e.g., penicillin) to look for its effect on various visual characteristics of treated cells. Once these effects are known, one could then look for agents with a similar morphological effect on cells. In this manner, one could quickly screen for novel agents with effects similar to those of known pharmacological agents.

The invention also provides a system for carrying out this method. The system may include a microscope able to acquire images at various magnifications or resolutions, a microprocessor, and software for carrying out the image analysis and the statistical analysis of the raw data derived from the images. In certain embodiments, a low magnification is useful where many cells are to be analyzed. In other embodiment, a high magnification is useful when analyzing for a characteristic only visible at high power. In addition to magnification, the resolution of the image may be varied depending on the analysis to be performed. In certain embodiments, a low resolution image is preferred for carrying out the automated analysis. The system may also include a storage device for storing the images and/or data for future recall if need be.

### BRIEF DESCRIPTION OF THE DRAWING

FIG. 1 shows two views of phenotype-transcriptional profiling and cytological profiling.

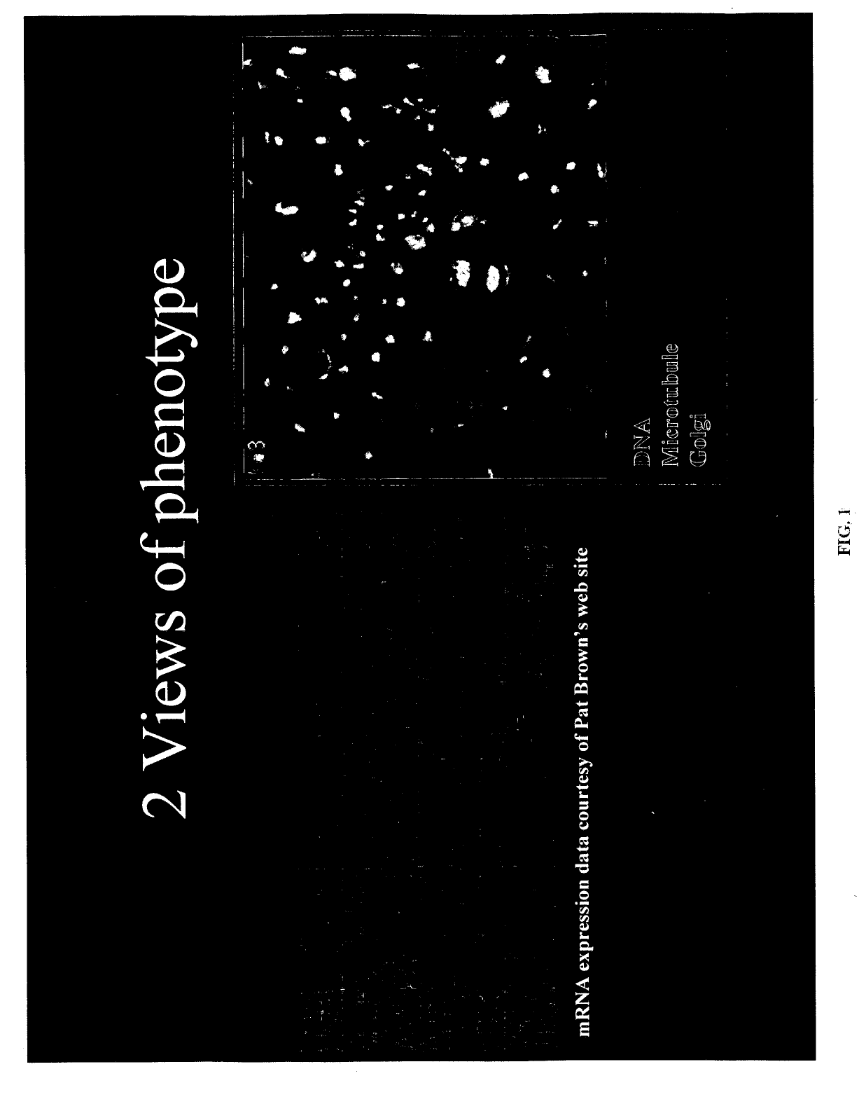

FIG. 2 shows a diagram of how cytological profiling can be used in high throughput analysis.

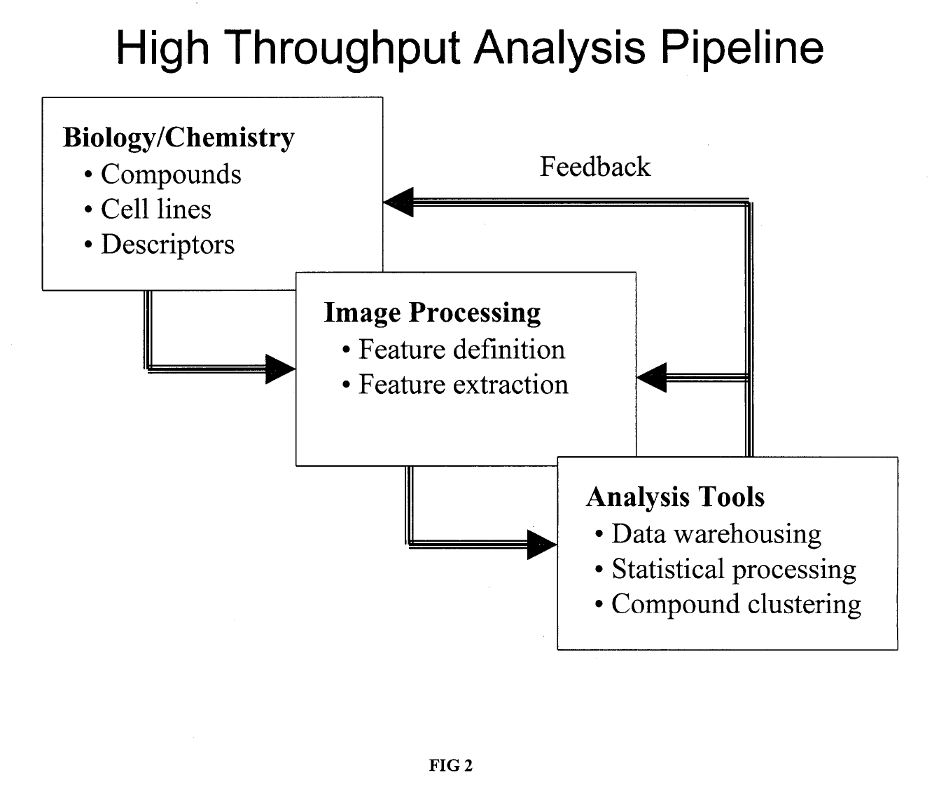

FIG. 3 shows the design of a typical experiment involving 60 compounds at various concentrations to yield over 10 million measurements or 6 GB of numerical data.

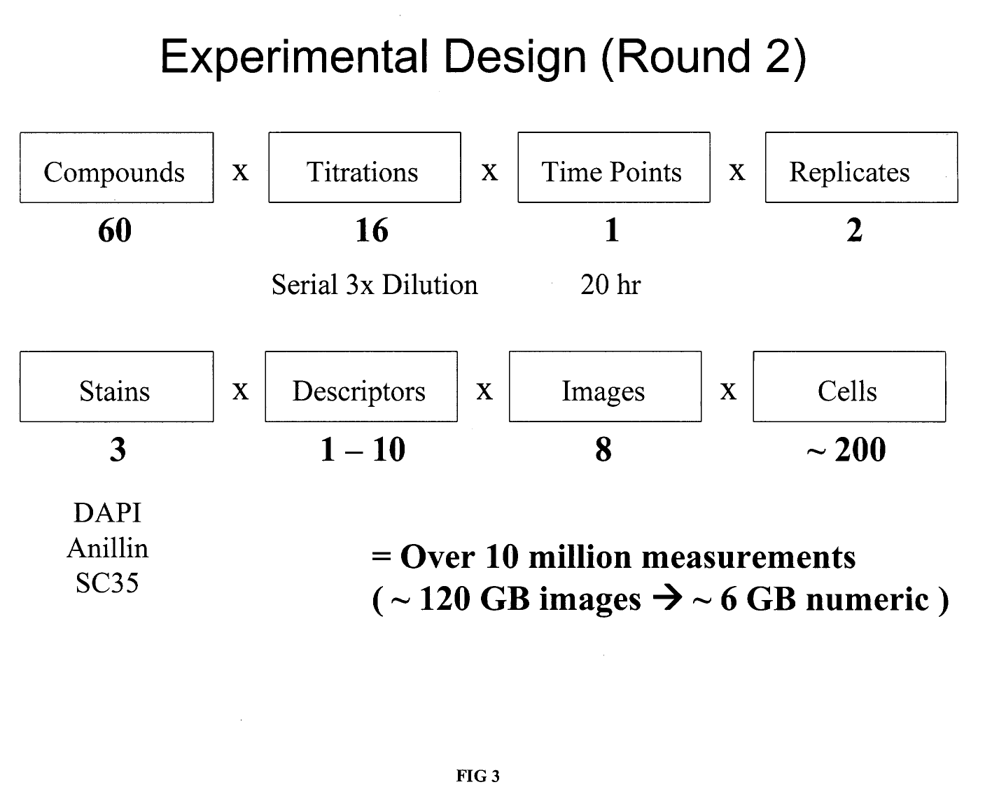

FIG. 4 shows the imaging of cells, processing of the image, measurement of shape and intensity values for each object, and statistical analysis.

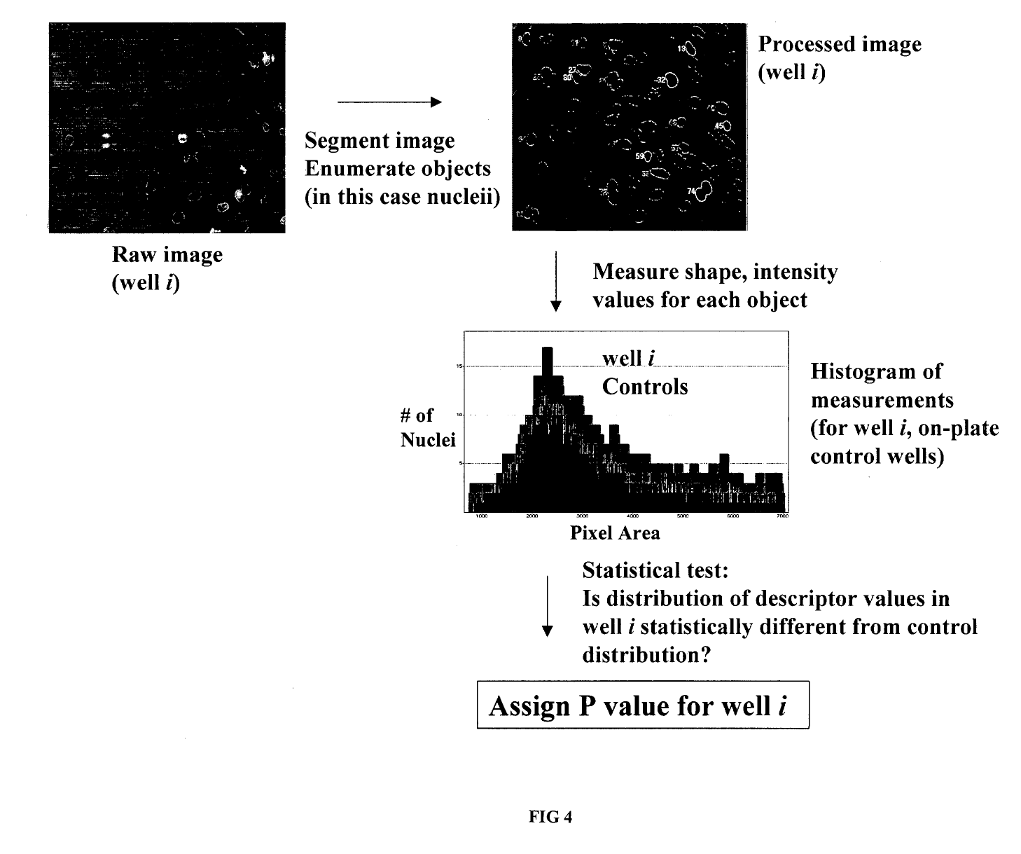

FIG. 5 shows the nine descriptors used in the experiment outlined in FIG. 3.

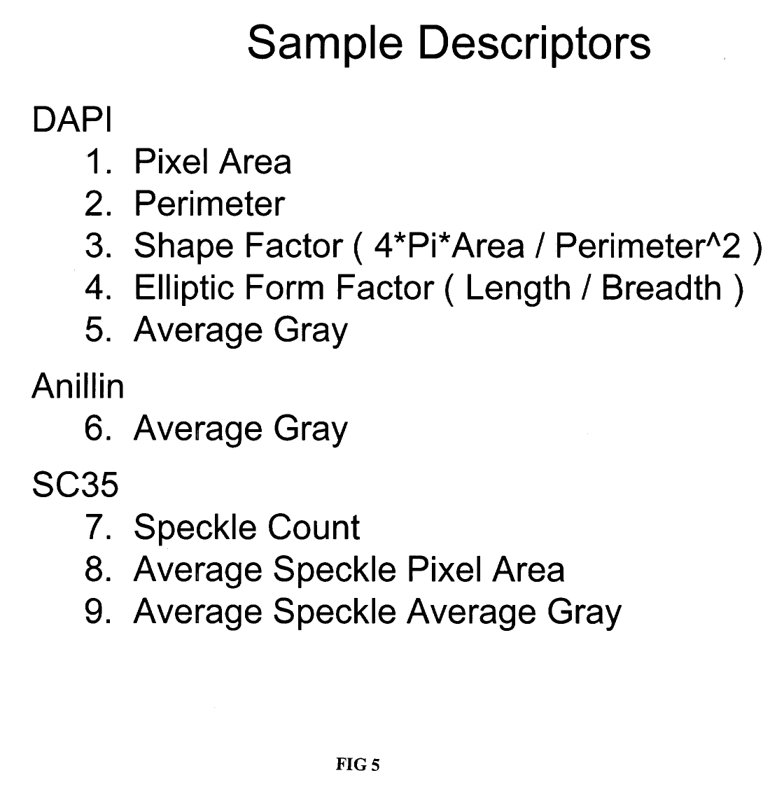

FIG. 6 shows two distributions of the average gray descriptor using the DAPI stain with cells contacted with cytochalasin D.

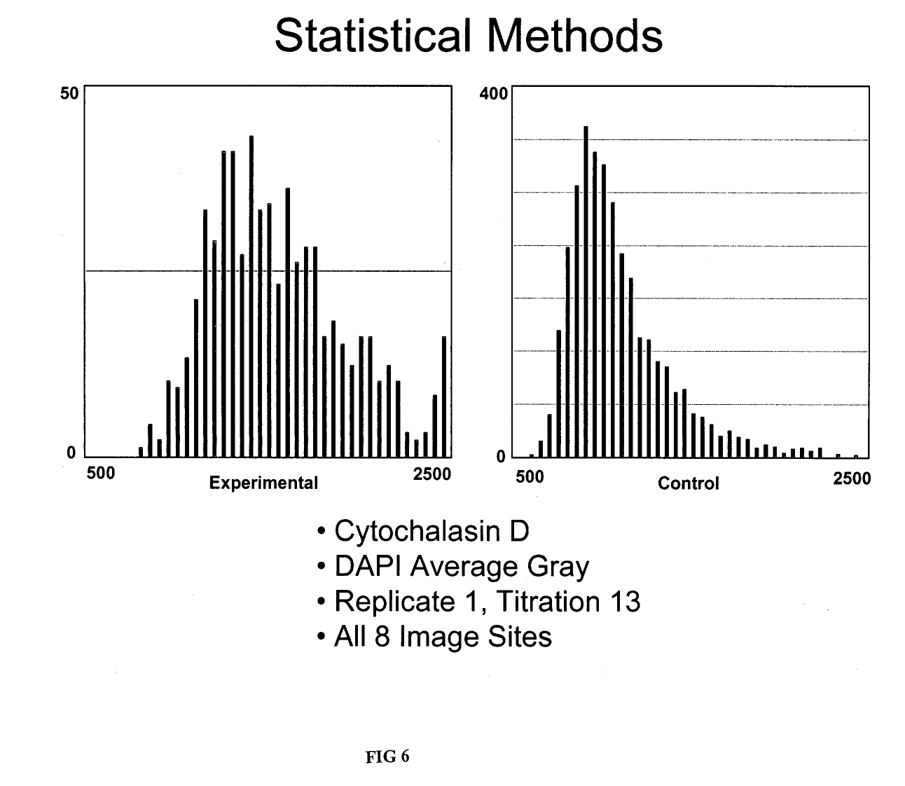

FIG. 7 shows a KS plot of the DAPI pixel area (nuclear size) descriptor at 20 hours for 40 compounds at different dilutions and an untreated control.

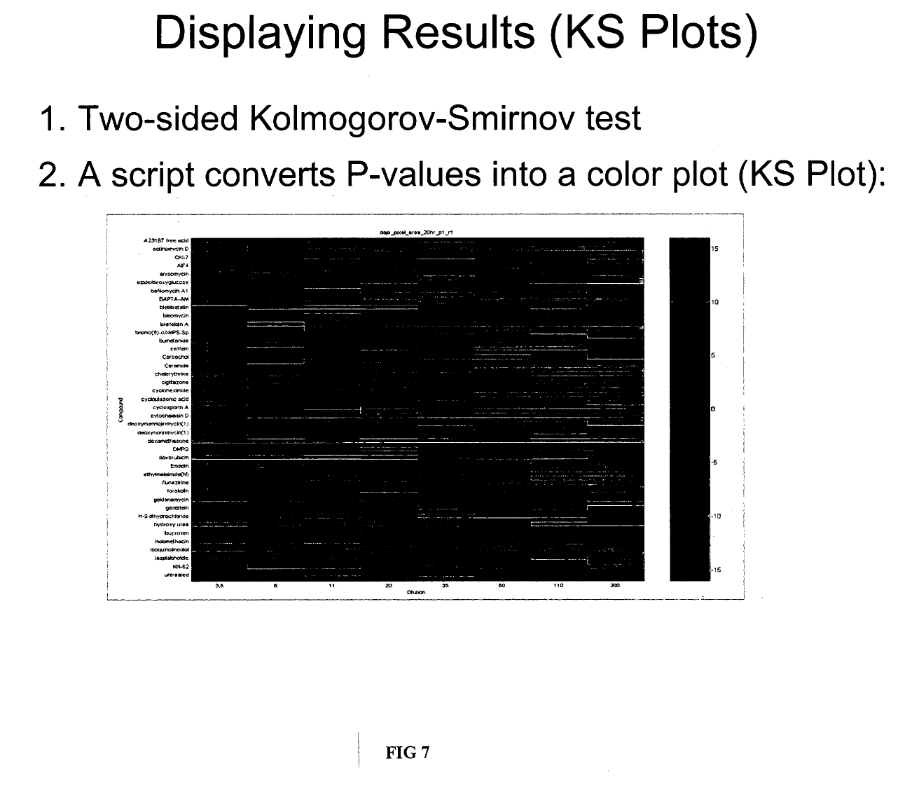

FIG. 8 shows the expanded KS plot of the nuclear size descriptor at 20 hours for actinomycin D, blebbistatin, brefeldin A, cycloheximide, and doxorubicin at eight different concentrations.

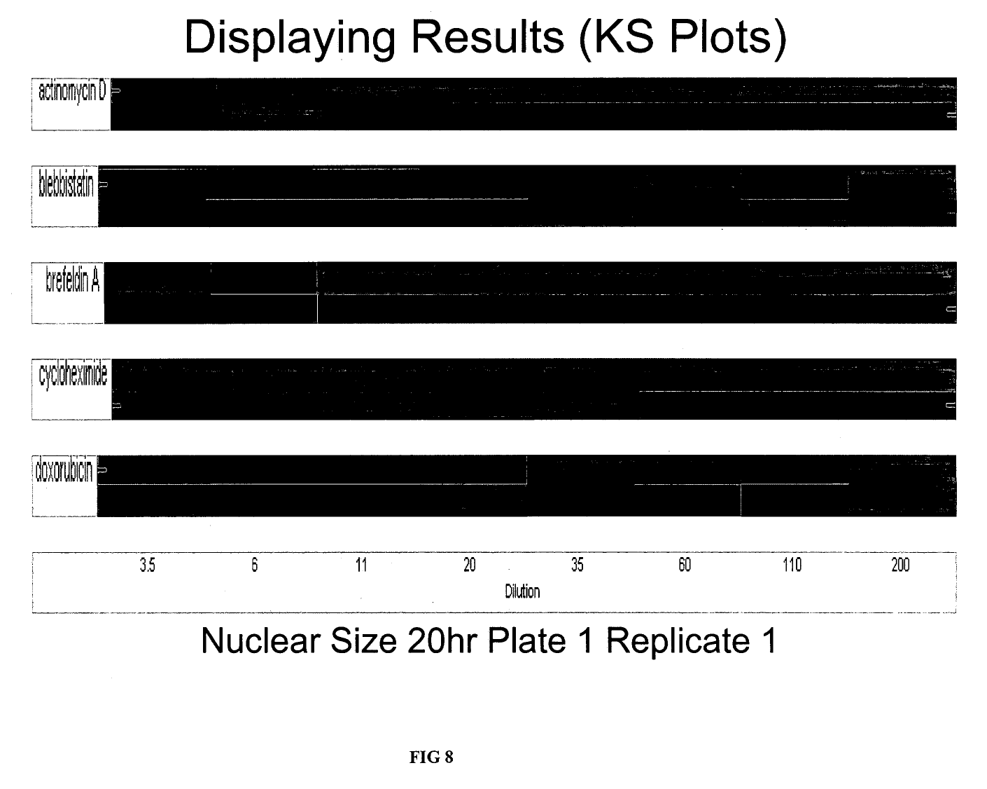

FIG. 9 shows the interpretation of the KS plots.

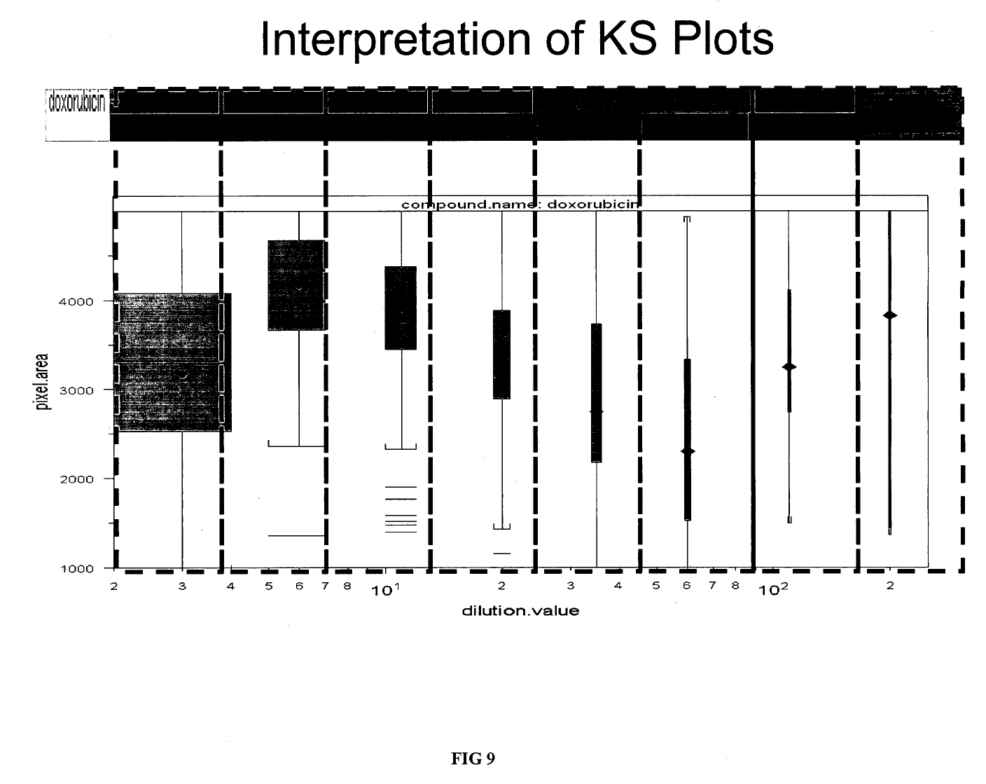

FIG. 10 shows the KS plot for nuclear size for brefeldin A, dexamethasone, doxorubicin, and control, and the corresponding images.

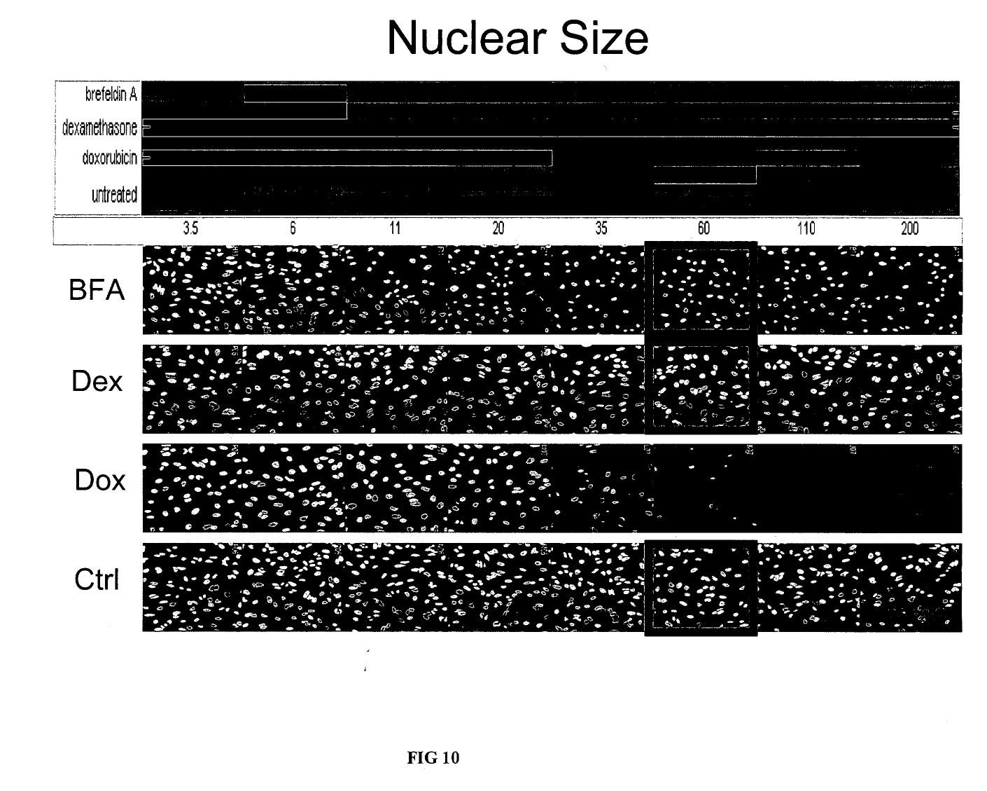

FIG. 11 shows the KS plot for nuclear speckle count for actinomycin D, brefeldin A, doxorubicin, and untreated control, and corresponding images.

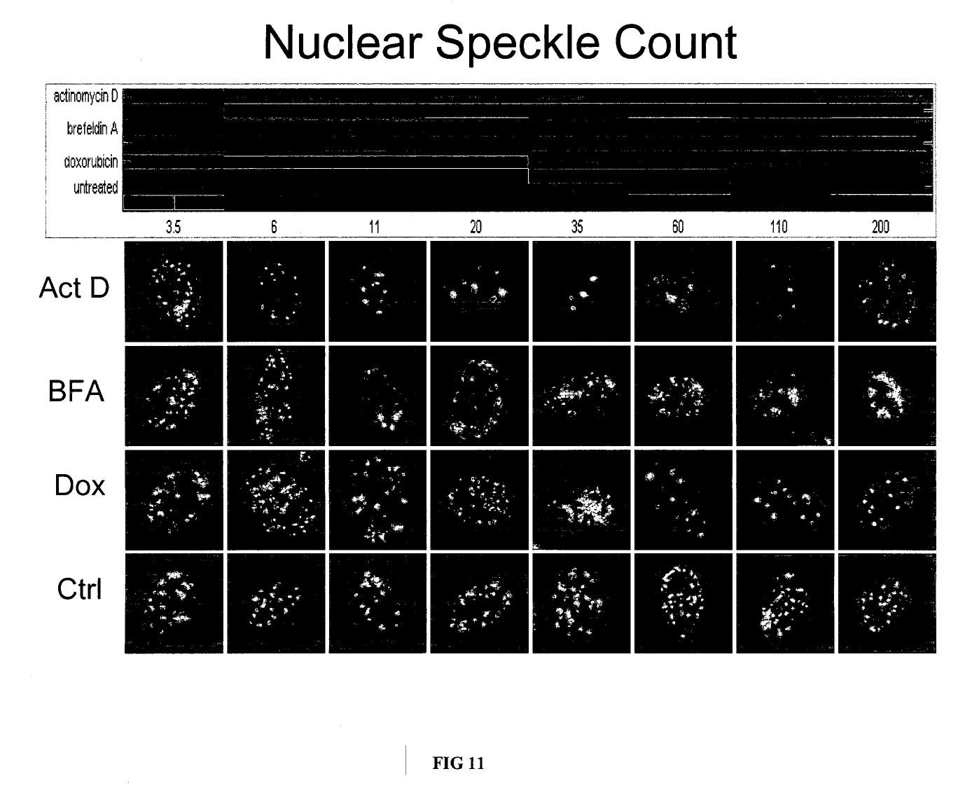

FIG. 12 shows the empirical cumulative distribution function of the control and experimental distributions and the calculation of the Kolmogorov-Smirnov statistic.

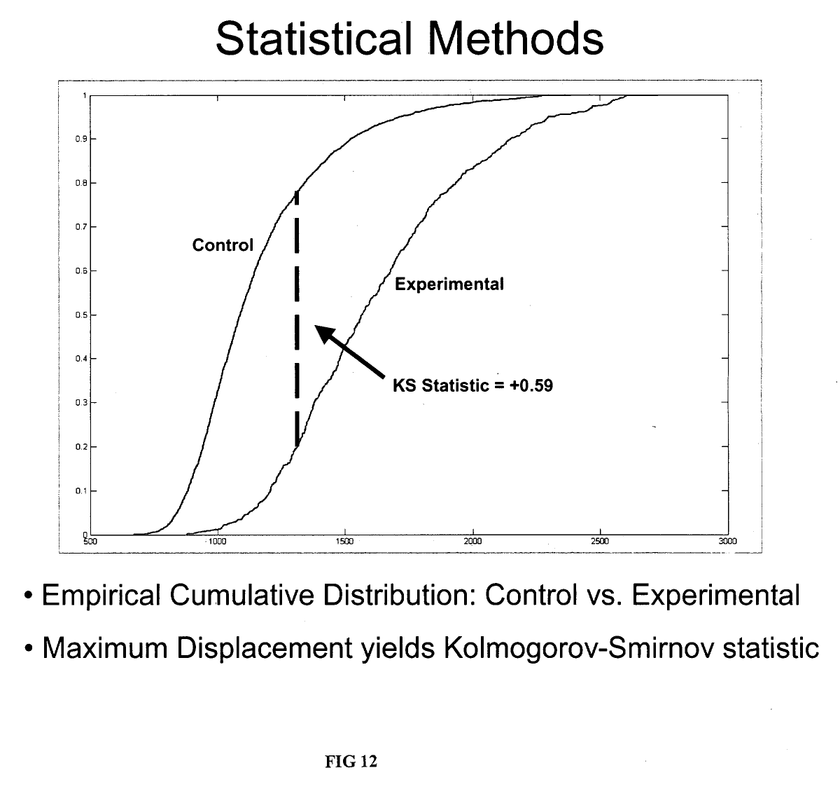

FIG. 13 displays the results using a KS plot of the nine descriptor (two replicates) for cytochalasin D.

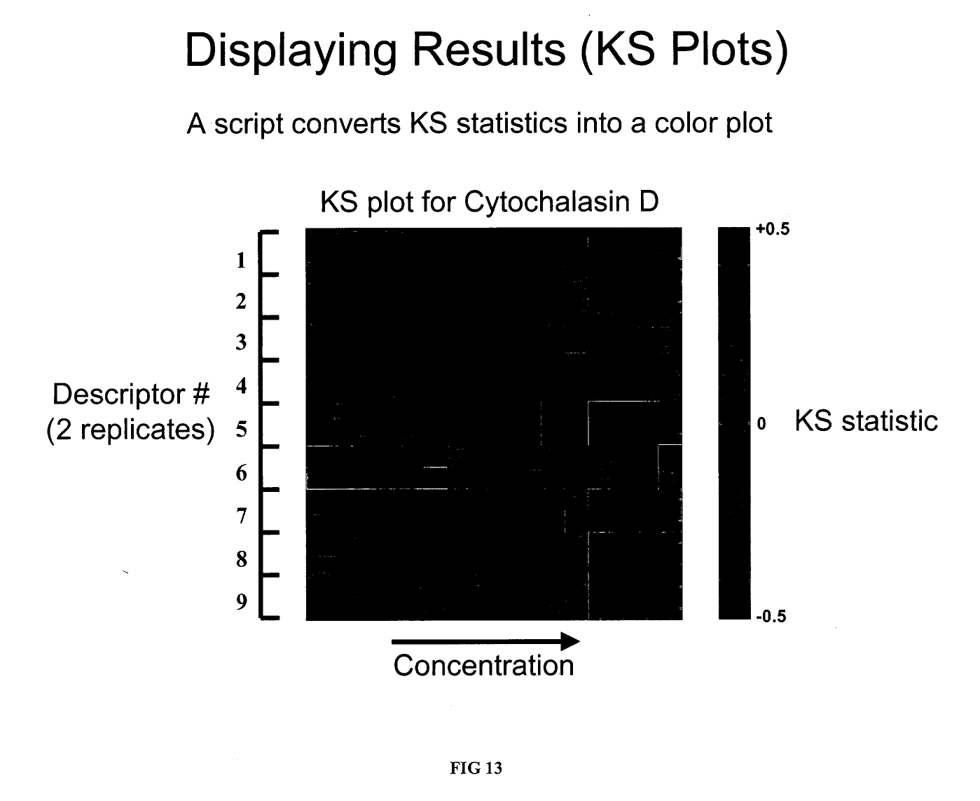

FIG. 14 is a KS plot showing a noisy descriptor and replicates that do not seem to be very reproducible.

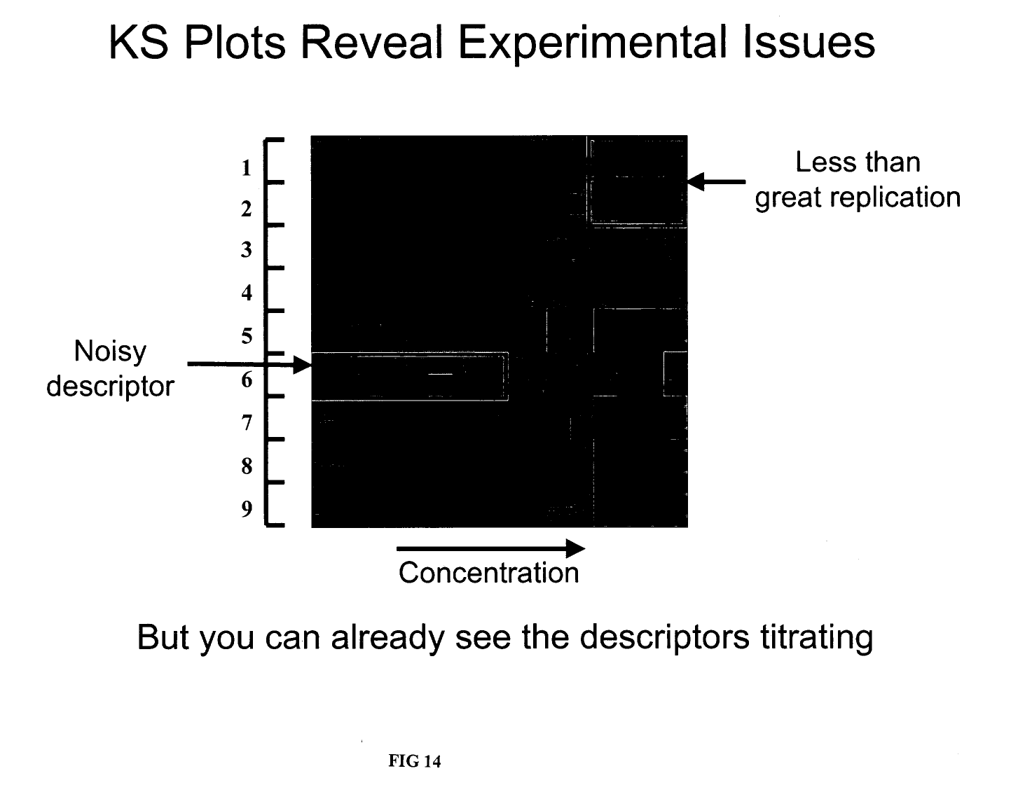

FIG. 15 shows the KS data for three compounds, cytochalasin D, jasplakinoldie, and latrunculin B, which are known to affect actin metabolism.

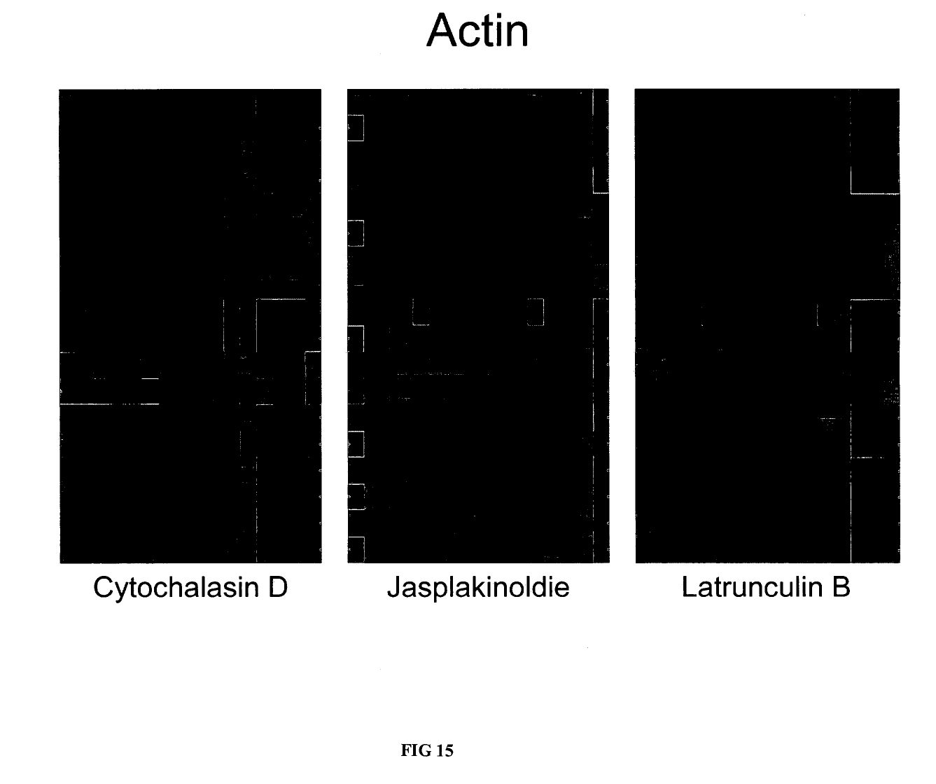

FIG. 16 shows the KS data for three compounds, 105D, colchicine, and griseofulvin, which are known to affect tubulin metabolism.

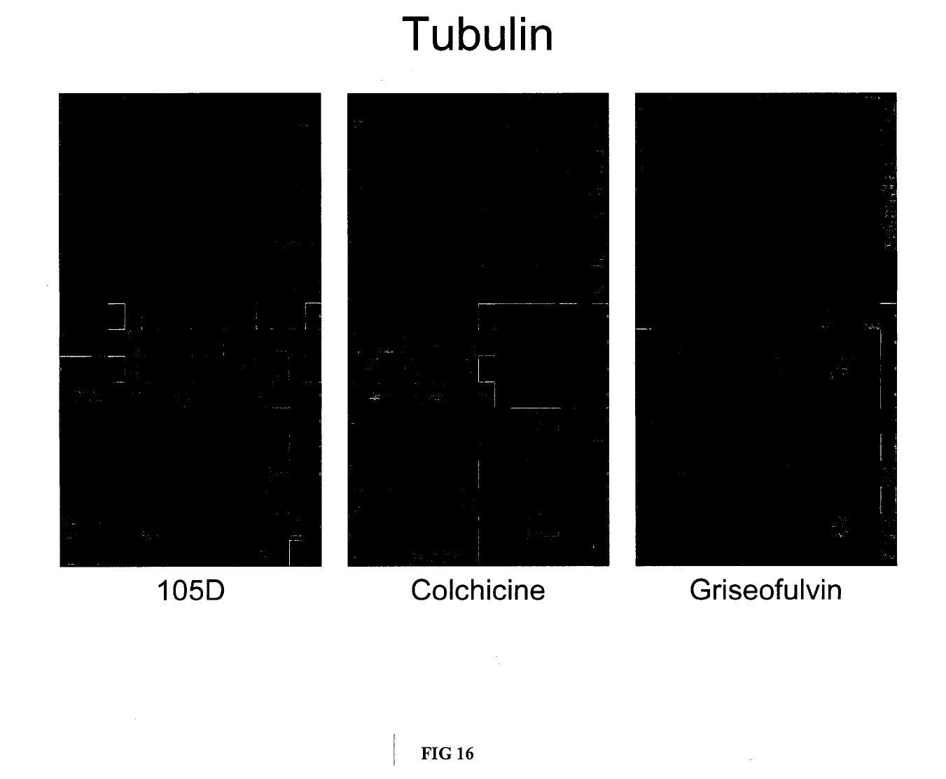

FIG. 17 shows the KS data for three compounds, nocodazole, podophyllotoxin, and taxol, which are known to affect tubulin metabolism.

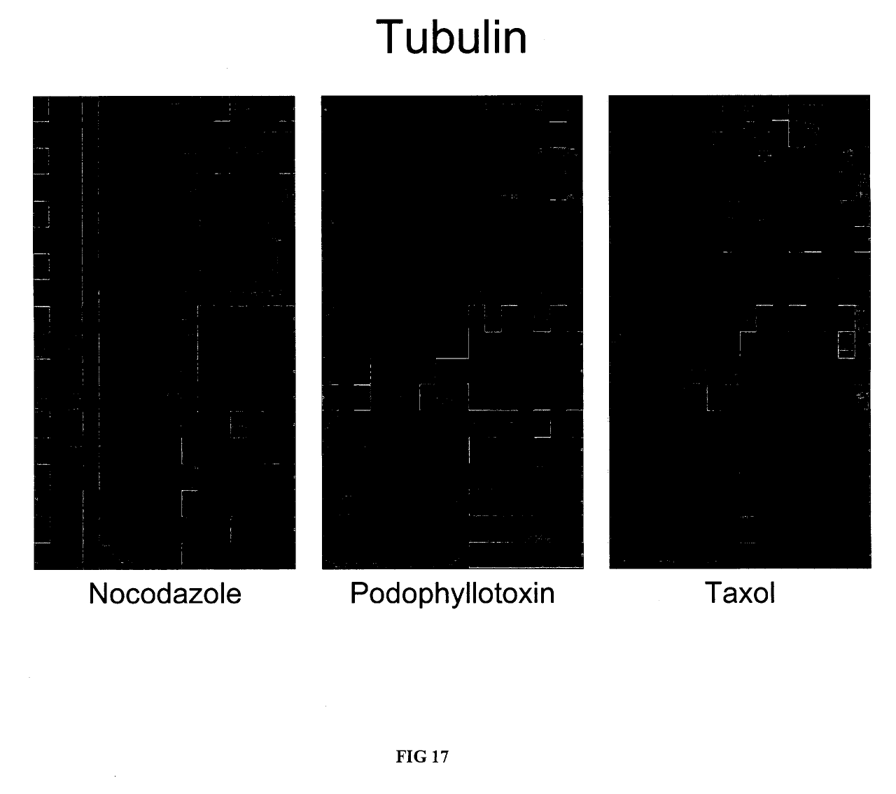

FIG. 18 shows the KS data for vinblastine, which is known to affect tubulin metabolism.

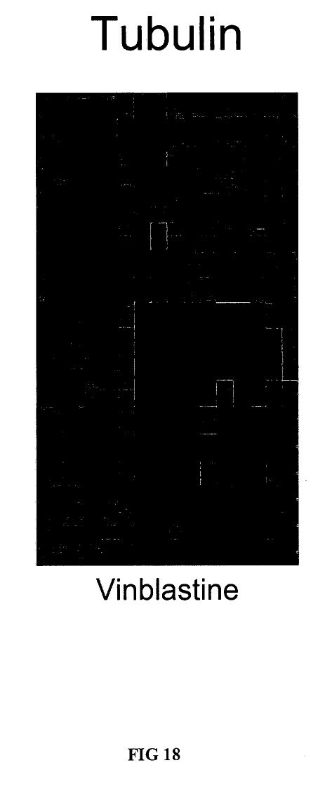

FIG. 19 shows the KS data for camptothecin, doxorubicin, and etoposide, which are known to affect topoisomerase activity.

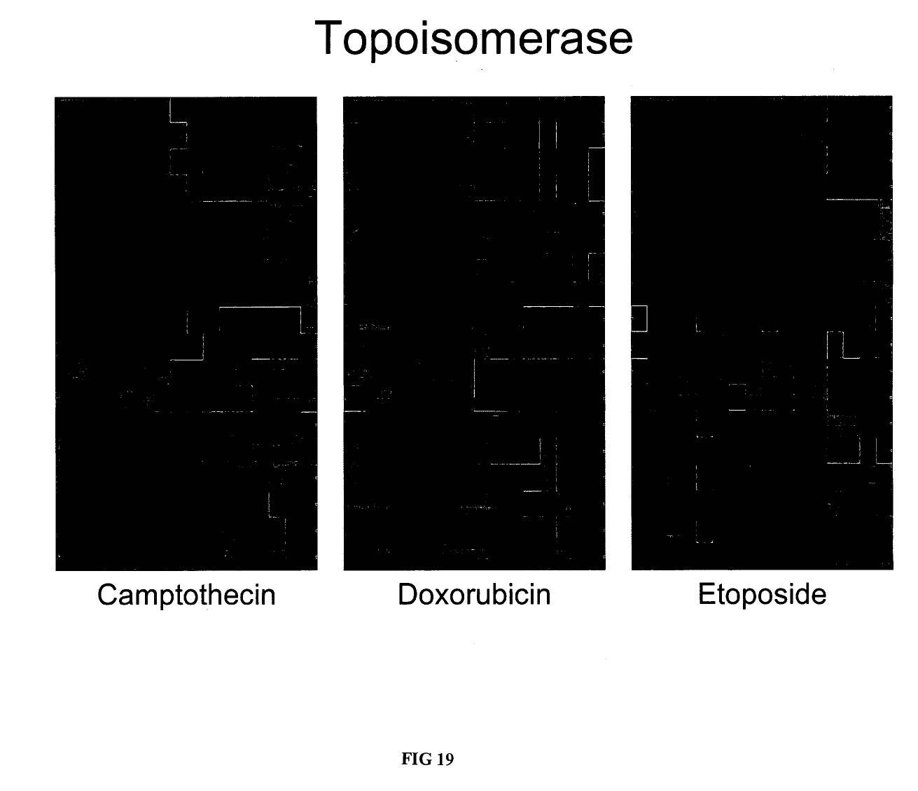

FIG. 20 shows the KS data from anisomycin, cycloheximide, and emetine, which are known to bind to ribosome and affect protein synthesis in cells.

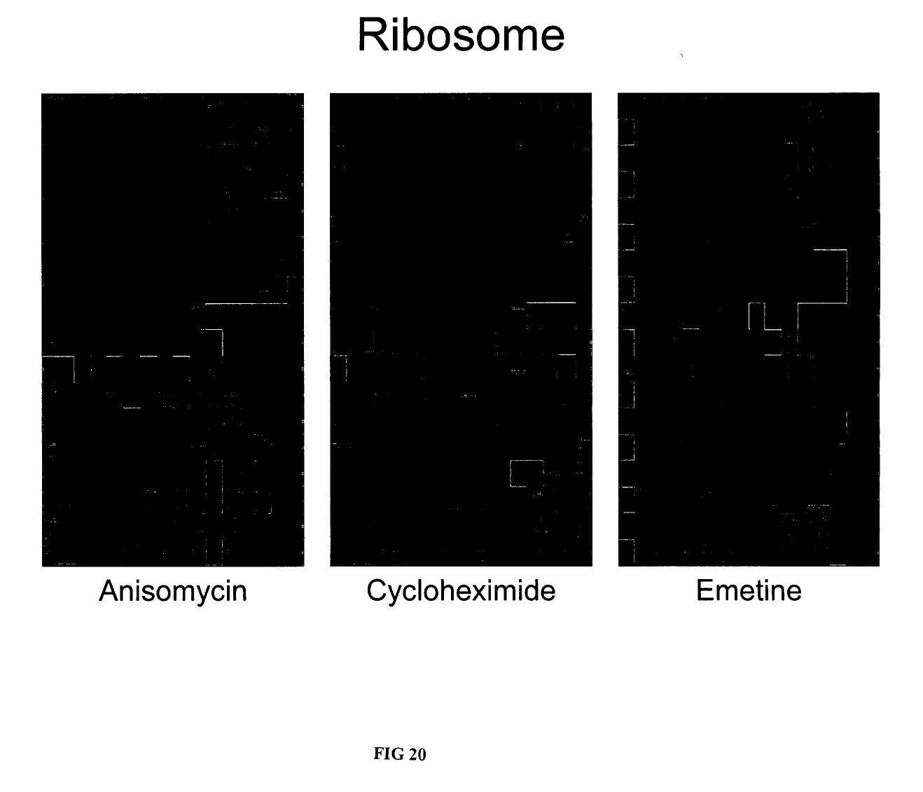

FIG. 21 shows the KS data from puromycin, which is also known to bind ribosomes and thereby affect protein synthesis in cells.

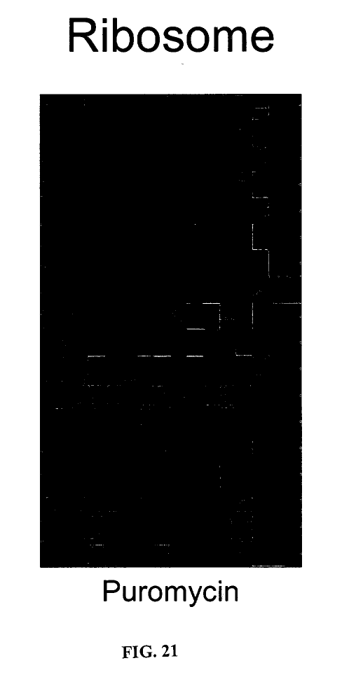

FIG. 22 shows the KS data from ibuprofen, indomethacin, and sulindac sulfide, which are inhibitors of cyclooxygenase.

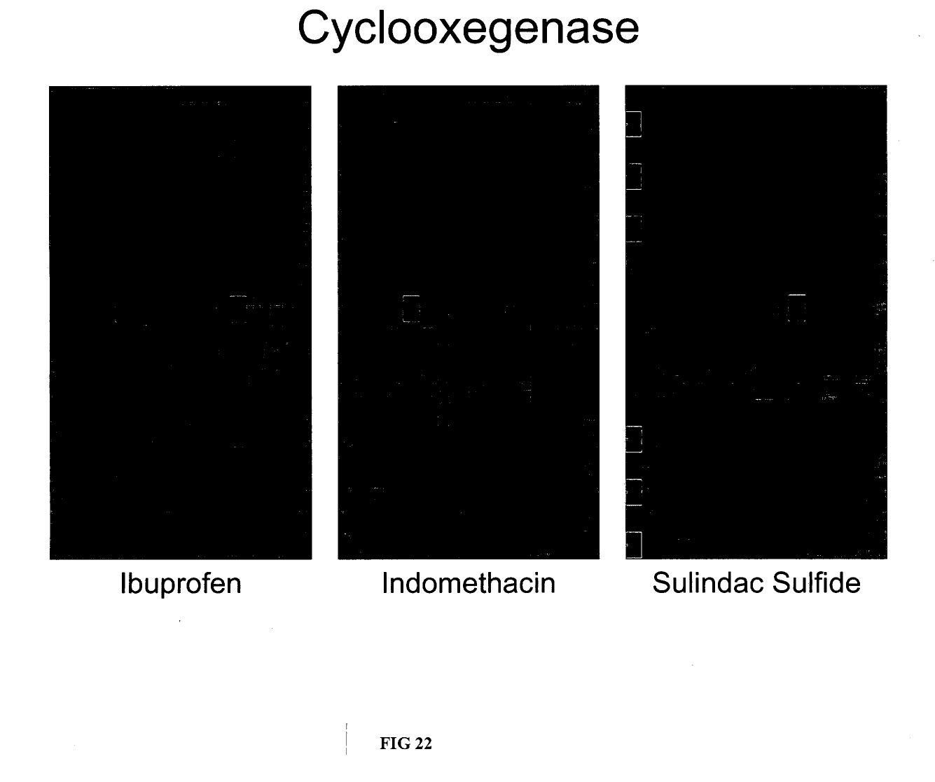

FIG. 23 shows the KS data from alsterpaullone, indirubin monoxime, and olomucine, which inhibits CDK.

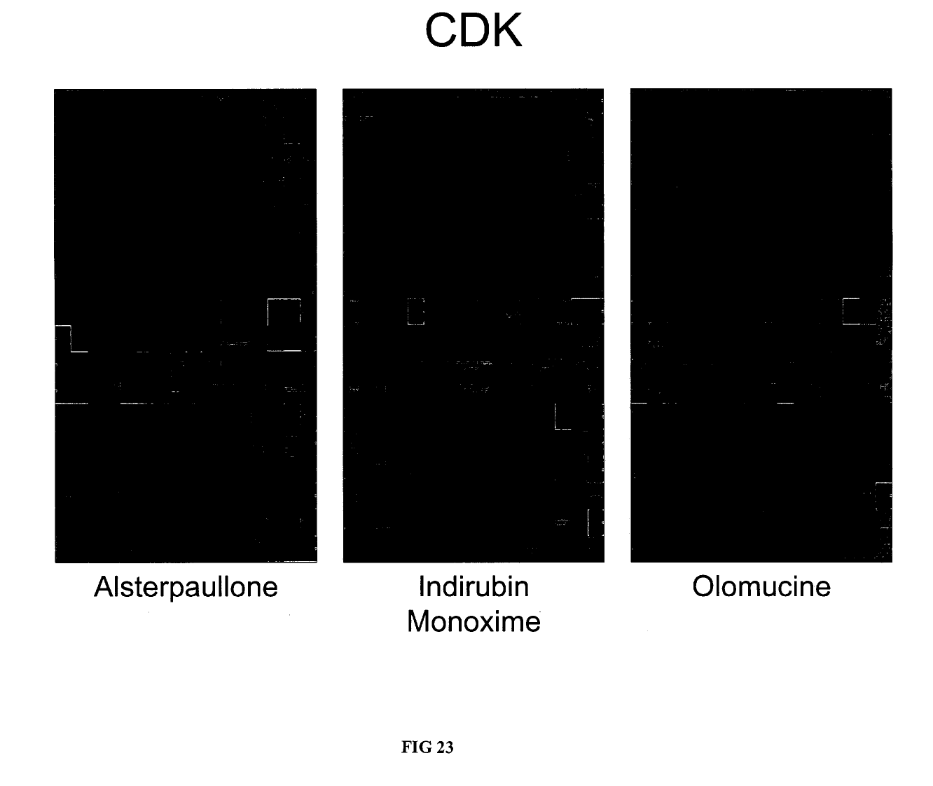

FIG. 24 shows the KS data from purvalanol A, which inhibits CDK.

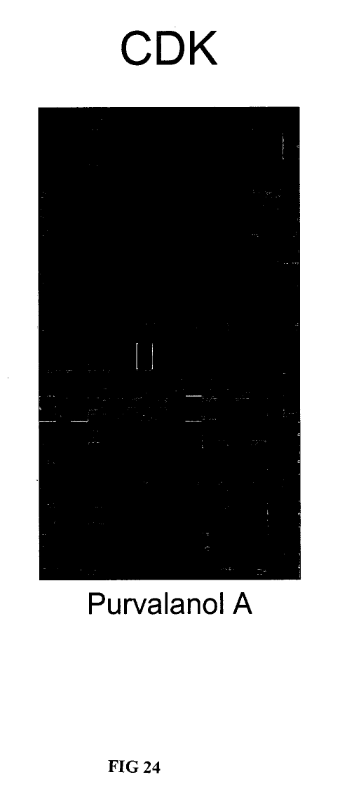

FIG. 25 shows the simple clustering of compounds listed on the right. Clustering provides a baseline for metric comparisons, is useful for evaluating reproducibility, replicates cluster reasonably well, and shows similar mechanism of action (e.g., tubulin).

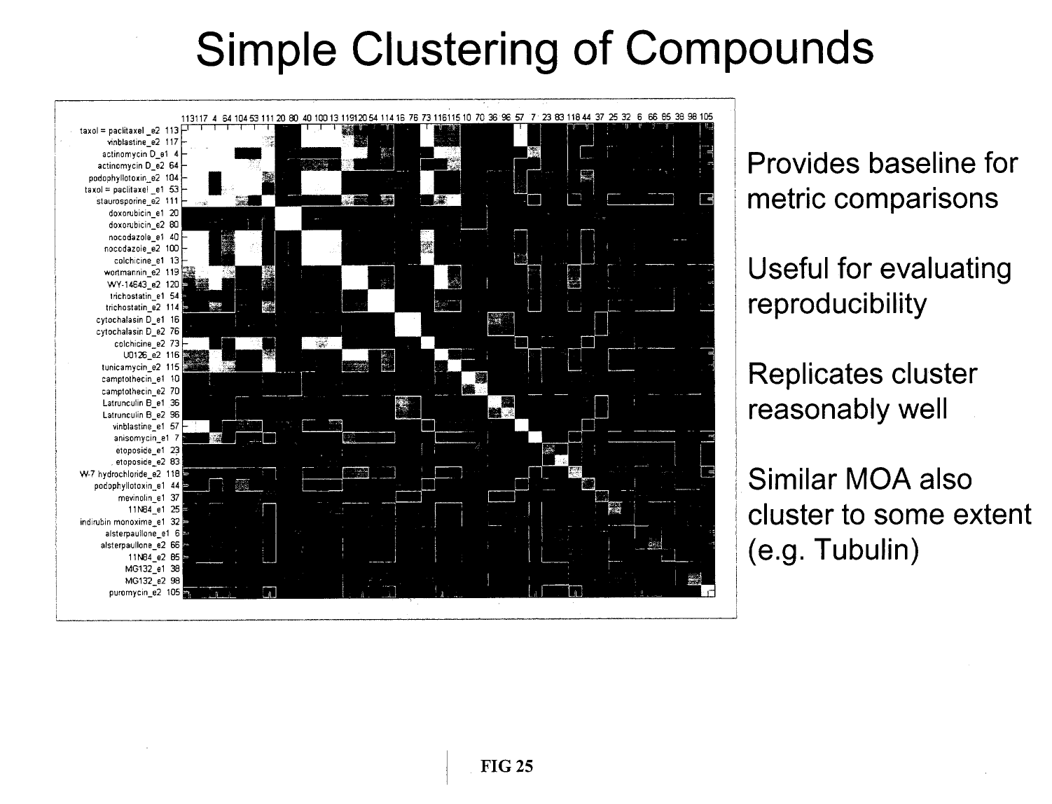

FIG. 26 shows the clustering of descriptors listed on the right—spliceosome average pixel area, spliceosome average grey, anillin average grey, spliceosome speckle count, DAPI average grey, DAPI pixel area, DAPI perimeter, DAPI perimeter, DAPI shape factor, and DAPI elliptic form factor. Clustering of descriptors is useful for evaluating descriptors, is useful for evaluating reproducibility, and replicates cluster reasonably well.

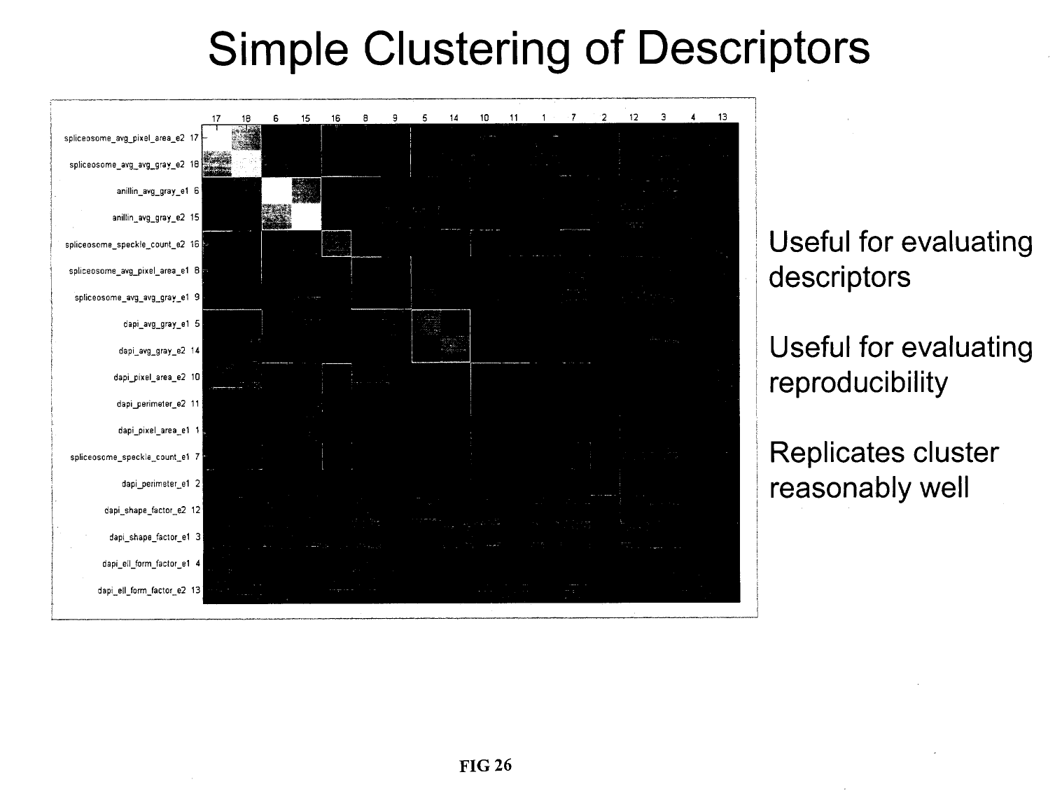

FIG. 27 shows more sophisticated clustering allowing for combing descriptors that are noise-tolerant, are dependent on relative concentration, and ignore absolute concentration. One way is by rank ordering the descriptors by concentration at which they undergo an inflection, noting if deflection is up or down.

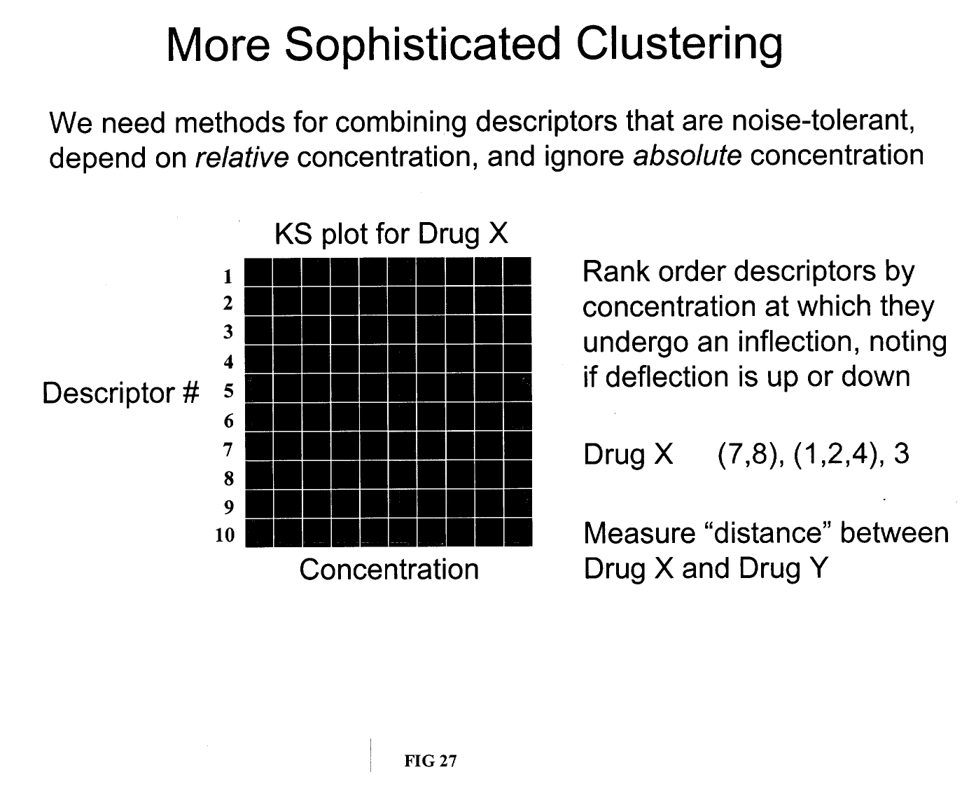

FIG. 28 shows clustering based on similar mechanisms of action (e.g., actin, tubulin, ribosome, and cyclooxygenase).

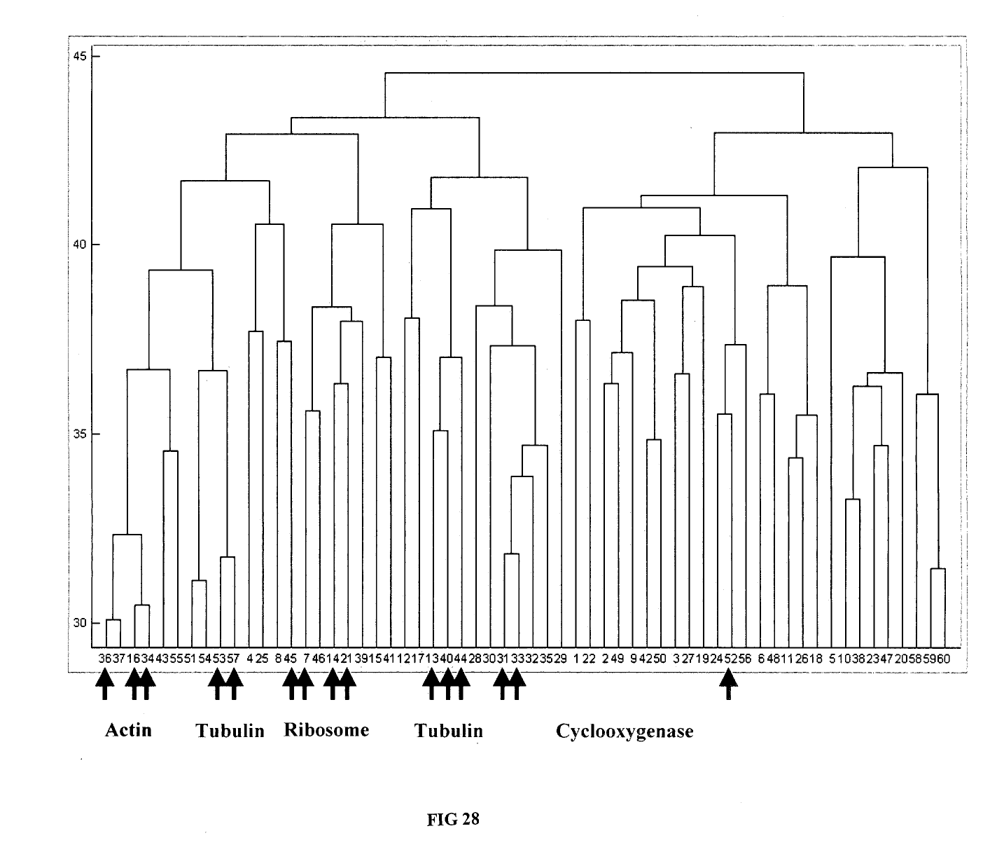

FIG. 29 shows analysis of clustering metrics by plotting percent true by total positives.

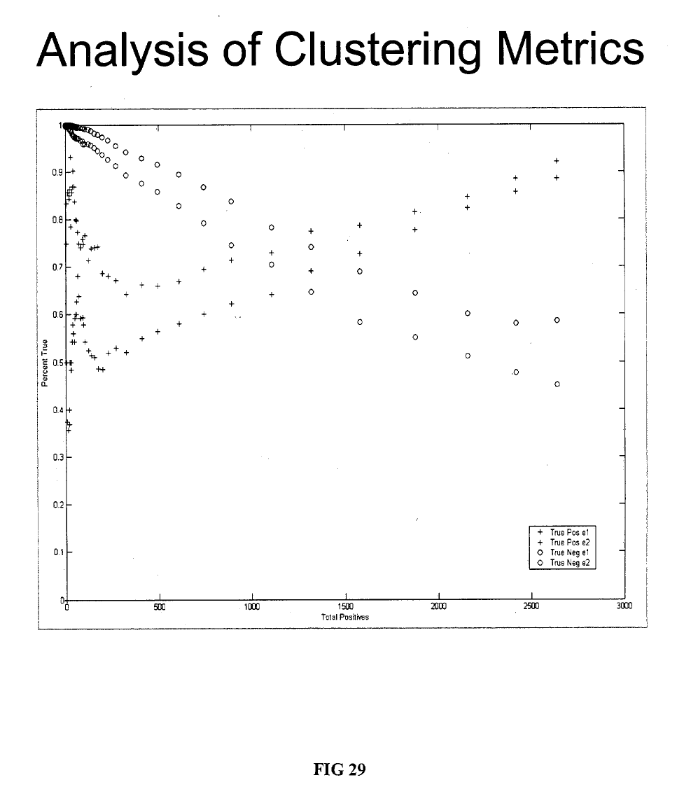

FIG. 30 shows analysis of clustering metrics by plotting percent true negatives by percent true positives.

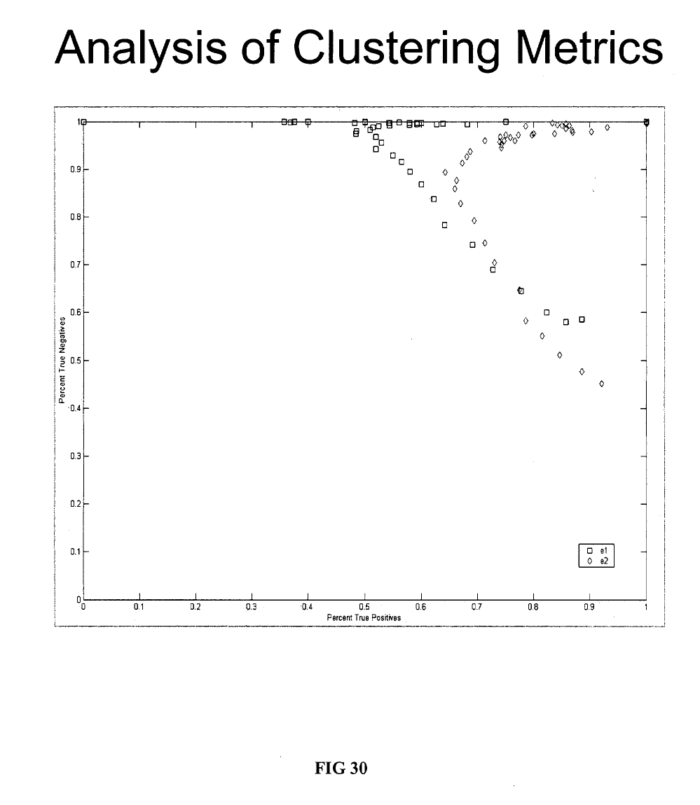

### DEFINITIONS

An agent is any chemical compound being contacted with the cells being analyzed by cytological profiling. These chemical compounds may include biological molecules such as proteins, peptides, polynucleotides (DNA, RNA, RNAi), lipid, sugars, etc.), natural products, small molecules, polymers, organometallic complexes, metals, etc. In certain embodiments, the agent is a small molecule. In other embodiments, the agent is a nucleic acid or polynucleotide. In yet other embodiments, the agent is a peptide or protein. In other embodiments, the agent is a non-polymeric, non-oligomeric chemical compound.

The Kolmogorov-Smirnov statistic (Chakravarti, Laha, and Roy, (1967) Handbook of Methods of Applied Statistics, Volume I, John Wiley and Sons, pp. 392-394) is used to decide if a sample comes from a population with a specific distribution. The Kolmogorov-Smirnov (K-S) test is based on the empirical distribution function (ECDF). Given N ordered data points Y1, Y2, . . . , YN, the ECDF is defined as where n(i) is the number of points less than Yi and the Yi are ordered from smallest to largest value. This is a step function that increases by 1/N at the value of each ordered data point. An attractive feature of this test is that the distribution of the K-S test statistic itself does not depend on the underlying cumulative distribution function being tested. Another advantage is that it is an exact test (the chi-square goodness-of-fit test depends on an adequate sample size for the approximations to be valid). Despite these advantages, the K-S test has several important limitations: (1) it only applies to continuous distributions; (2) it tends to be more sensitive near the center of the distribution than at the tails; (3) perhaps the most serious limitation is that the distribution must be fully specified. That is, if location, scale, and shape parameters are estimated from the data, the critical region of the K-S test is no longer valid. It typically must be determined by simulation. Due to limitations 2 and 3 above, many analysts prefer to use the Anderson-Darling goodness-of-fit test. However, the Anderson-Darling test is only available for a few specific distributions. The Kolmogorov-Smirnov test is defined by: H0: the data follow a specified distribution; Ha: the data do not follow the specified distribution; Test Statistic: the Kolmogorov-Smirnov test statistic is defined as where F is the theoretical cumulative distribution of the distribution being tested which must be a continuous distribution (i.e., no discrete distributions such as the binomial or Poisson), and it must be fully specified (i.e., the location, scale, and shape parameters cannot be estimated from the data).

A peptide or protein comprises a string of at least three amino acids linked together by peptide bonds. Peptide may refer to an individual peptide or a collection of peptides. Inventive peptides preferably contain only natural amino acids, although non-natural amino acids (i.e., compounds that do not occur in nature but that can be incorporated into a polypeptide chain) and/or amino acid analogs as are known in the art may alternatively be employed. Also, one or more of the amino acids in an inventive peptide may be modified, for example, by the addition of a chemical entity such as a carbohydrate group, a phosphate group, a farnesyl group, an isofarnesyl group, a fatty acid group, a linker for conjugation, functionalization, or other modification, etc.

Polynucleotide or oligonucleotide refers to a polymer of nucleotides. The polymer may include natural nucleosides (i.e., adenosine, thymidine, guanosine, cytidine, uridine, deoxyadenosine, deoxythymidine, deoxyguanosine, and deoxycytidine), nucleoside analogs (e.g., 2-aminoadenosine, 2-thiothymidine, inosine, pyrrolo-pyrimidine, 3-methyl adenosine, 5-methylcytidine, C-5 propynyl-cytidine, C-5 propynyl-uridine, 2-aminoadenosine, C5-bromouridine, C5-fluorouridine, C5-iodouridine, C5-propynyl-uridine, C5-propynyl-cytidine, C5-methylcytidine, 2-aminoadenosine, 7-deazaadenosine, 7-deazaguanosine, 8-oxoadenosine, 8-oxoguanosine, O(6)-methylguanine, and 2-thiocytidine), chemically modified bases, biologically modified bases (e.g., methylated bases), intercalated bases, modified sugars (e.g., 2′-fluororibose, ribose, 2′-deoxyribose, arabinose, and hexose), or modified phosphate groups (e.g., phosphorothioates and 5′-N-phosphoramidite linkages).

Small molecule refers to a non-peptidic, non-oligomeric organic compound either synthesized in the laboratory or found in nature. Small molecules, as used herein, can refer to compounds that are “natural product-like”, however, the term “small molecule” is not limited to “natural product-like” compounds. Rather, a small molecule is typically characterized in that it contains several carbon-carbon bonds, and has a molecular weight of less than 1500, although this characterization is not intended to be limiting for the purposes of the present invention. Examples of small molecules that occur in nature include, but are not limited to, taxol, dynemicin, and rapamycin. In certain other preferred embodiments, natural-product-like small molecules are utilized.

### DETAILED DESCRIPTION OF PREFERRED EMBODIMENTS

The present invention provides for methods and systems of analyzing various aspects of a cell or population of cells which can be visualized using microscopy. These phenotypic aspects of the cell may be quantified in certain embodiments. This data can then be analyzed later to derive various categories, correlations, or trends among different populations of cells which may have been treated in different ways (e.g., different drugs, different agents, different concentrations, different RNAi's, different time points). The inventive method comprises imaging the cells, and analyzing the acquired images for various phenotypic aspects of the cells. The phenotypic aspects of the cells in a population may be quantitated and statistically analysed, and this data may be compared to data from a control set of cells or cells subjected to different conditions. The data can then be clustered to find cells of similar phenotypes in order to find compounds of a known activity or mechanism of action.

Cell samples. Any test sample containing cells may be evaluated using the inventive method. The cells may be specially prepared for light microscopy, or they may be imaged and analyzed with no special preparations. In certain embodiments, the cells are imaged while they are still alive and immersed in media or other suitable solutions. The media or solution may contain staining or dyeing agents to enhance the visualization of certain feature of the sample such as certain cell types, cellular organelles, connective tissue, nucleic acids, proteins, etc. The cell samples may be in individual culture dishes coated with a suitable substrate such as poly-lysine, or they may be in multiple well plates such as 8, 16, 32, 64, 96, or 384-well plates. In experiments in which arrays of cells are being analyzed, a multi-well plate is preferable as would be appreciated by one of skill in the art.

In other embodiments, the cell samples are prepared for light microscopy by fixing the cells to a slide and staining the samples using stains known in the art. In certain embodiments, chemical compounds known to stain a particular types of cells or cellular organelle are used in the preparation of the cells. These stains may be fluorescent under specific conditions (e.g., a specific wavelength). In certain embodiments, the stains are small molecule dyes such as DAPI (4′,6-diamidino-2-phenylindole), acridine orange, hydroethidine, etc. Other stains may include Acid Fuchsin, Acridine Orange, Alcian Blue 8GX, Alizarin, Alizarin Red S, Alizarin Yellow R, Amaranth, Amido Black 10B, Aniline Blue Water Soluble, Auramine O, Azure A, Azure B, Basic Fuchsin Reagent A.C.S., Basic Fuchsin Hydrochloride, Benzo Fast Pink 2BL, Benzopurpurin 4B, Biebrich Scarlet Water Soluble, Bismarck Brown Y, Brilliant Green, Brilliant Yellow, Carmine, Lacmoid, Light Green SF Yellowish, Malachite Green Oxalate, Metanil Yellow, Methylene Blue, Methylene Blue Chloride, Methylene Green, Methyl Green, Methyl Green Zinc Chloride Salt, Methyl Orange Reagent A.C.S., Methyl Violet 2B, Morin, Naphthol Green B, Neutral Red, New Fuchsin, New Methylene Blue N, Nigrosin Water Soluble, Nigrosin B Alcohol Soluble, Nile Blue A, Nuclear Fast Red, Oil Red O, Orange II, Orange IV, Orange G, Patent Blue, 4-(Phenylazo)-1-naphthalenamine Hydrochloride, Phloxine B, Ponceau G R 2R, Ponceau 3R, Ponceau S, Procion Blue HB, Prussian Blue, Pyronin B, Pyronin Y, Quinoline Yellow SS, Rhodamine 6G, Rhodamine B Base Alcohol Soluble, Rhodamine B O, p-Rosaniline Acetate Powder, Rose Bengal, Rosolic Acid, Saffron, Safranine O, Stilbene Yellow, Sudan I, Sudan II, Sudan III, Sudan IV, Sudan Black B, Sudan Orange G, Tartrazine, Thioflavine T TG, Thionin, Toluidine Blue O, Tropaeolin O, Trypan Blue, Ultramarine Blue, Victoria Blue B, Victoria Blue R, Xylene Cyanol FF, Xylene Cyanol FF, Alizarin, Alizarin carmine (for staining bone), Alizarin red S (sodium monosulfonate) monohydrate, Alum carmine, Amaranth, Arsenazo III, Basic red 2 (Cotton red; Gossypimine; Safranin A or O or Y), Bismark brown, Bromocresol green, Bromocresol purple, Bromophenol blue, Bromophenol red, Bromothymol blue, Calcein, Calcon (Eriochrome black B), Clayton yellow (Thiazole yellow), Coomassie blue (Brilliant blue), Cotton Red (Basic red 2; Gossypimine; Safranin A or O or Y), Cresol red sodium salt, Cupferron, 2′,7′-Dichloro fluorescein, Dicyanobis (1,10-phenanthroline)Iron, Diethyldithiocarbamic acid silver salt, 4,7-Diphenyl-1,10-phenanthroline-x.x-disulfonic acid diNa salt, Diphenylthiocarbazone, Dithizone, Eosin bluish, Eosin Y, Eriochrome black B (Calcon), Eriochrome black T, Eriochrome blue, Eriochrome blue black R, Eriochrome blue SE, Eriochrome gray SGL, Eriochrome red B, Erionglaucine (A), Erythrosin B, Fast Green FCF, Fuchsin acid, Fuchsin basic (Pararosaniline HCI), Gentian Violet, Gossypimine (Basic red 2; Cotton red; Safranin A or O or Y), Hematoxylin, Hydroxy Naphthol blue, Indigo blue pigment, Janus green B, Methyl orange, Methyl orange, Methyl red, Methyl thymol blue, Methyl violet B (Aniline violet; Dahlia violet B), Methyl violet base (Solvent violet 8), Methylene blue, Murexide indicator, Neutral red, Orange G, Orange IV, Owen's blue, Patent blue (Acid blue 1), Pararosaniline HCI (Basic fuchsin), Phenolphthalein, Phenol red, Phlorglucinol dihydrate, Pyronine Y (or G), Safranin, Safranin A or O or Y (Basic red 2; Cotton red; Gossypimine), Solvent violet 8 (Methyl violet base), Sudan III, Sudan IV, Thiazole yellow (Clayton yellow), Thymol blue, Thymolphthalein pH indicator 9.4-10.6, Wright's stain, Xylene cyanole FF, Chromotrope 2B, Chromotrop 2R, Clayton Yellow; Cochineal Red A, Congo Red, Coomassie® Brilliant Blue G-250, Coomassie® Brilliant Blue R-250, Cotton Blue, Crocein Scarlet 3B, Curcumin, Diazo Blue B, Eosin B, Eosin B Water Soluble, Eosin Y, Eriochrome Black A, Eriochrome Black T Reagent A.C.S., Eriochrome Blue Black R, Eriochrome Cyanine R, Erioglaucine, Erythrosin B, Ethyl Eosin, Ethyl Violet, Evans Blue, Fast Garnet GBC Base, Fast Garnet GBC Salt, Fast Green FCF, Fluorescein Alcohol Soluble U.S.P., Fluorescein Alcohol Soluble, Fluorescein Water Soluble, Hematoxylin, 8-Hydroxy-136-pyrenetrisulfonic Acid Trisodium Salt; Indigo Synthetic, Indigo Carmine, Indophenol Blue, Indulin Water Soluble, and Janus Green B. In other embodiments, the stains may include labeled or unlabeled antibodies specific for a particular protein or antigen such p53, p38, p43, fos, c-fos, jun, NF-κB, anillin, SC35, CREB, STET3, SAMD, FKHD, D4G, calmodulin, calcineurin, actin, microtubulin, ribosomal proteins, receptors, cell surface antigens such as CD4, etc. In other embodiments, stains for Golgi markers, endosomal markers (e.g., EA1), lysosomal markers (e.g., LAMP-1, LAMP-2), and mitochondrial markers are used.

The cell samples which can be analyzed using the inventive method can be derived from any source. The cells may be derived from any species of animal, plant, bacteria, fungus, microorganism, or single-celled organism. Examples of sources include E. coli, Saccharomyces cerevisiae, S. pombe, Candida albicans, C. elegans, Arabidopsis thaliana, rats, mice, pigs, dogs, and humans. In certain embodiments in which chemical compounds are being screened for biological activity in humans, the cells are of mammalian origin, preferably of primate origin and even more preferably of human origin. In certain embodiments, the cells are well-known experimental cell lines which have been characterized extensively and have been found to perform reproducibly under various experimental conditions. Examples of such cells lines include various bacterial and yeast cells lines, HeLa cells, COS cells, NCI 60 cells, and CHO cells. In certain embodiments, the cell line used for cytological profiling is the HeLa cell line. In other embodiments, the cell lines used is the NCI 60 cell line. In certain embodiments, the cells may be derived from known cell lines, cultures, or tissue/cell samples from surgical, pathological, or biopsy specimens. If the cells being analyzed are part of a specimen, the cells may be an integral part of an organ or tissue and therefore be surrounded by connective tissue, extracellular matrix, support cells such as fibroblasts, blood cells, etc., blood vessels, lymphatics, etc.

The cell used in the sample may be wild type cells or may have been altered. The genome of the cells may have been altered using techniques known in the art to enhance the expression of a gene, decrease the expression of a gene, delete a gene, modify a gene, etc. The cells may also be treated with various chemical agents (e.g., small molecules, pharmaceutical agents, chemical compounds, biological molecules, proteins, polynucleotides, anti-sense agents such as RNAi, etc.) known to have a specific biological effect such as, for example, cytochalasin D, jasplakinoldie, latrunculin B, 105D, colchicine, griseofulvin, podophyllotoxin, taxol, vinblastine, actinomycin D, staurosporine, camptothecin, doxorubicin, etoposide, anisomycin, emetine, puromycin, tunicamycin, anisomycin, mevinolin, wortmannin, trichostatin, ibuprofen, indomethacin, sulindac sulfate,; alsterpaullone, indirubin monoxime, olomucine, purvalanol A, cycloheximide, or nocodazole. Any combination of genetic and/or chemical alterations may also be used. For example, the cells may be genetically engineered to stop the cells in the cell cycle, and then chemical compounds from a library of compounds may be added to the genetically altered cells to identify compounds which patch the genetic defect.

As discussed supra, the cell samples may be provided as arrays of cells-each element of the array representing a separate experiment in which the cells have been subjected to different conditions. For example, each well of a multi-well plate may be treated with a different test agent, different concentration, different temperature, or different time point to determine its effect on the cells. In certain embodiments, the array of cells has at least one element containing cells which are untreated and therefore serve as a control. In certain embodiments, several elements of the array may serve as a control to enhance reliability and reproducibililty. The cells may optionally be fixed and stained before images of the cells are acquired. In other embodiments, images of the cells may be obtained while the cells are alive so that the cells can be analysed at later time points or the cells can be further treated with agents.

Image acquisition. The cells to be analyzed using the inventive method are first imaged to obtain the raw data that will be analyzed to determine the phenotypic characteristics of the cells. The number of cells to be imaged may range from a single cell to less than 100 cells to less than 500 cells to over a thousand cells. In certain embodiments, (the number of cells in a field to be imaged range from 100-200 cells, preferably approximately 200 cells. In certain embodiments, images with less than 10 cells are discarded. In other embodiments, images with less than 50 cells are discarded. Multiple images of the cells may be taken at different wavelengths to assess staining with different fluorescent dyes. Multiple images may also be taken in each well in order to reduce noise and increase reproducibility in the experiments. For example, five to ten images may be acquired in each well at different non-overlapping regions. The cells can be imaged using any method known in the art of light or fluorescence microscopy.

Images may be obtained digitally using a digital image capture device such as a CCD camera or the equivalent, or they may be obtained conventionally using standard film technology and then digitized from the film (e.g., using a scanner). In either case, the camera may be connected to a microscope. In a preferred embodiment, the images are acquired digitally by a CCD camera directly mounted to a microscope, thereby eliminating the additional step of digitizing an analog image.

The magnification chosen to image the cells may range from very low magnification 5× to very high magnification 5000×. In certain embodiments, the magnification ranges is 10×, 20×, 50×, 100×, 200×, 500×, or 1000×. As would be appreciated by one of skill in this art, the magnification would depend on various factors including the number of samples to be imaged, the number of cells per samples, and the aspects of the cells to be analyzed. For example, analysis for cell shape and morphology would typically require less magnification than imaging subcellular organelles such as the nucleus and centrosomes. In certain embodiments, the cells may be imaged at multiple magnifications in order to better assess several different aspects of the cells. In other embodiments, a magnification is chosen as a compromise between various competing factors so that the cells are only imaged once.

An appropriate resolution (pixels per image) of the digitized image must be selected, whether the images are originally acquired by digital means or are scanned from conventional micrographs. As will be understood by those of ordinary skill in the art, resolution is typically selected so that features of interest (e.g., whole cells, nuclei, or centromeres) comprise a sufficient number of pixels that their morphological characteristics (e.g., average diameter, area, perimeter, shape factor) may be determined with a sufficient accuracy at the selected magnification, while not exceeding available computing power and/or data storage. If a camera with very fine resolution (i.e., a large number of pixels per imaged frame) is not available, a higher magnification may be used. In such cases, more image frames may be acquired for each specimen in order to image a statistically significant number of cells.

In certain embodiments, the images are acquired using a digital camera mounted on a standard laboratory microscope. The images may then be stored and analyzed later by a computer, or they can be analyzed as they are acquired. Images may be stored in any appropriate file format, including lossy formats such as jpg and gif or lossless formats such as tiff and .bmp. Alternatively, only analysis results may be stored.

Cell features may be identified using standard thresholding and edge detection techniques. Such techniques are described, for example, in U.S. Pat. No. 5,428,690 to Bacus et al., U.S. Pat. No. 5,548,661 to Price et al., and U.S. Pat. No. 5,848,177 to Bauer et al., all of which are incorporated by reference herein. Once the cell features have been identified by one of these methods, quantitative morphological data about each feature may be collected, such as area, perimeter, shape factor (commonly defined as the ratio of 4π(Area)/(Perimeter)²), aspect ratio, and gray level statistics (such as the average gray level and the standard deviation in the gray level for a particular feature).

Data Analysis. Once the images have been analysed for the specific cell characteristics and the characteristics have been quantified, any statistical methods known in the art can be used to determine the differences between two sets of data. In certain embodiments, a distribution of cells with a certain characteristic from a particular experiment may be used in statistically analysing the characteristic. In certain embodiments, a set of experimental data involving a specific drug, at a particular concentration, and at a certain time point will be compared to a set of control data where no drug has been added. In other embodiments, experimental data with a first agent may be compared to experimental data with a second agent; or one concentration versus another concentration; or one time point versus another. In other embodiment, statistical analysis may be performed on more than two sets of data resulting in a 3-way, 4-way, 5-way, or multi-way analysis.

In certain embodiments, distribution are obtained for each set of data collected. Two distributions may be compared by comparing the heights of the two distributions, the widths of the two distributions (e.g., the width at the base, the width at half-height), continuous distribution functions of the two distributions, etc. In comparing the continuous distribution functions, one can determine the maximum distance or displacement between the two curves (i.e., the Kolmogorov-Smirnov statistic), the integration or area between the two curves, the maximum height difference between the two curves, the intersection of the two curves, etc.

In certain embodiments, two sets of distribution data are compared using Kolmogorov-Smimov statistics. Distributions of each data set are determined, and empirical cumulative distribution functions are calculated. The continuous distribution functions from each of the sets of data being compared are analysed to determine the maximum displacement between the two cumulative distribution functions. The maximum displacement is a signed statistic known as the Kolmogorov-Smimov statistic (KS statistics). In certain preferred embodiments, one set of data is experimental and the other is a control. The resulting KS statistics from multiple experiments can then be assigned a color and plotted in an array so that the KS statistics from many different experiments can be visually assessed.

Clustering algorithms can then be used to cluster data sets which are similar. For example, clustering can be used to identify replicates of a compound within a set of data. Also, clustering can be used to cluster data from a compound with a known activity to data from a compound with a similar mechanism of action.

Clustering can also be used to better refine the cellular characteristics (descriptors) being evaluated. For example, clustering can be used to determine which descriptors can provide information that is independent or non-overlapping, or new correlations between descriptors.

Applications. Morphological analysis or cytological profiling of cells can be used in a wide variety of applications, for example, histology, pathology, drug screening, drug development, drug susceptibility screens, etc. In certain embodiments, chemical compounds are contacted with the cells, and the cells are imaged after a certain time period. In certain embodiments, different concentrations of the chemical compound dissolved in a suitable solvent such as medium, water, DMF, or DMSO are used. The cells are then imaged, and the data gathered from the images is analysed to determine trends among different compounds or different descriptors.

In one embodiment, cytological profiling is used in drug discovery. First, a set of chemical compounds or drugs with known biological activity or mechanism of action, known as the training set, are contacted with cells at various concentrations and statistical data on various descriptors is gathered and analysed. Trends are then established for certain compounds with known modes of action. For example, compounds that affect protein synthesis may affect certain descriptors while compounds that affect tubulin polymerization may affect other descriptors. After these trends have been established, a set of chemical compounds of unknown activities (e.g., a newly synthesized combinatorial library) may be contacted with the same cells to look for the affect of each of the compounds on the cytological profile of the cells. Clustering analysis comparing the training set of compounds to the new set of experimental compounds is then used to determine which compounds of unknown mechanisms of actions may activities similar to compounds in the training set. Therefore, compounds more likely to have a desired activity can be quickly selected using cytological profiling.

These and other aspects of the present invention will be further appreciated upon consideration of the following Examples, which are intended to illustrate certain particular embodiments of the invention but are not intended to limit its scope, as defined by the claims.

### EXAMPLES

To determine the reproducibility of cytological profiling, a set of 60 chemical compounds of known activity or mechanism of action were contacted with NCI 60 cells grown in 384-well plates. Each of the compound was administered to the cells at 16 different concentrations. After 20 hours, the cells were imaged by taking 4 images per well with a 20× objective (approximately 400 cells). Two imaging replicates and two full experimental replicates were obtained resulting in 8 images per well and 16 images for each compound/concentration combination. These images (approximately 120 GB of image date) were then used to extract approximately 6 GB of numerical data. These numerical data was then analyzed using statistical analysis such as K-S statistics and clustering to look for correlations and trends among the 60 compound tested. The data was also used to test the reproducibility and reliability of cytological profiling.

384-well plates were seeded with NCI 60 cells. One of 60 different compounds (the “training set”) at a varying concentrationc was added to each well of the plate. The compounds included cytochalasin D, jasplakinoldie, latrunculin B, 105D, colchicine, griseofulvin, podophyllotoxin, taxol, vinblastine, actinomycin D, staurosporine, camptothecin, doxorubicin, etoposide, anisomycin, emetine, puromycin, tunicamycin, anisomycin, mevinolin, wortmannin, trichostatin, ibuprofen, indomethacin, sulindac sulfate, alsterpaullone, indirubin monoxime, olomucine, purvalanol A, cycloheximide, or nocodazol. Each of the compound was dissolved in DMSO and administered to the cells at 16 different concentrations (serial 3× dilution). The cells were then incubated for 20 hours. An experimental replicate was performed for each well to improve reliability and test reproducibility.

After 20 hours, the cells were fixed and stained using DAPI (a fluorescent probe for DNA), a fluorescent probe for anillin, and a fluorescent probe for SC35. Eight images were obtained from each well. Each image contained approximately 200 cells, and images with less than 10 cells were discarded from the data set.

The images were then analyzed using MetaMorph imaging software (version 5.0) (Universal Imaging Corporation). Numerical values for nine descriptors were determined using MetaMorph. Nuclei as imaged by the DAPI stain were identified by thresholding. The morphological data collected for each identified nucleus were the area in pixels, the perimeter in pixel widths, the shape factor (4π(Area)/Perimeter²), the elliptic form factor (i.e., the aspect ratio, defined as the ratio of the maximum length to the breadth), and the average gray level of the pixels comprising the nucleus. For the stain for anillin, average gray was the descriptor. For the stain for SC35, speckle count, average speckle pixel area, and average speckle average gray were the descriptors. Distributions were determined for each descriptor with a particular compound at a particular concentration. Distributions were also calculated for the descriptors of the control images from the untreated wells. From the distributions, empirical cumulative distribution functions were calculated. The Kolmogorov-Smimov statistic (the maximum displacement) was calculated for each experiment versus the control. The KS values were then assigned a color, and these colors for each descriptor was plotted against concentration in order to better visualize when changes were occurring for a particular compound. Clustering was then performed to identify replicates of a particular compound within a training set and to identify compound of a similar mechanism of action.

From the data obtained for the training set, one can predict the activity of compounds of unknown mechanism by comparing the K-S statistics of the training set with those of the new set of compounds. The experimental set of compounds is contacted with the cells, and the cells are imaged and analysed as described above.

### Other Embodiments

The foregoing has been a description of certain non-limiting preferred embodiments of the invention. Those of ordinary skill in the art will appreciate that various changes and modifications to this description may be made without departing from the spirit or scope of the present invention, as defined in the following claims.

1. A method of cell analysis, the method comprising steps of:
providing cells for analysis;
contacting the cells with a chemical compound;
imaging the cells;
analyzing image of cells for various visual characteristics; and
quantitating the visual characteristics of the cells.

2. The method of claim 1, wherein the cells are human cells.

3. The method of claim 1, wherein the cells are selected from the group consisting of HELA cells, COS cells, NCI 60 cells, and CHO cells.

4. The method of claim 1, wherein the cells are bacterial cells.

5. The method of claim 1, wherein cells are provided as arrays of cells.

6. The method of claim 1, wherein the cells are imaged at greater than 1000×.

7. The method of claim 1, wherein the cells are imaged at approximately 20× magnification.

8. The method of claim 1, wherein the cells are imaged at greater than 100× magnification.

9. The method of claim 1, wherein the cells are imaged at greater than 10× magnification.

10. The method of claim 1, wherein the cells are images at 6 megapixels per image or greater.

11. The method of claim 1, wherein the cells are imaged at 4 megapixels per image or greater.

12. The method of claim 1, wherein the cells are imaged at 2 megapixels per image or greater.

13. The method of claim 1, wherein the cells are images at 1 megapixel per image or greater.

14. The method of claim 1, wherein the step of imaging comprises staining the cells.

15. The method of claim 14, wherein the step of staining comprises contacting the cells with DAPI (4′,6-diamidino-2-phenylindole HCl).

16. The method of claim 14, wherein the step of staining comprises contacting the cells with a labeled-antibody directed against a cellular protein.

17. The method of claim 14, wherein the step of staining comprises contacting the cells with a labeled-antibody directed against anillin.

18. The method of claim 14, wherein the step of staining comprises contacting the cells with a labeled-antibody directed against SC35.

19. The method of claim 14, wherein the step of staining comprises contacting the cells with a stain selected from the group consisting of Acid Fuchsin, Acridine Orange, Alcian Blue 8GX, Alizarin, Alizarin Red S, Alizarin Yellow R, Amaranth, Amido Black 10B, Aniline Blue Water Soluble, Auramine O, Azure A, Azure B, Basic Fuchsin Reagent A.C.S., Basic Fuchsin Hydrochloride, Benzo Fast Pink 2BL, Benzopurpurin 4B, Biebrich Scarlet Water Soluble, Bismarck Brown Y, Brilliant Green, Brilliant Yellow, Carmine, Lacmoid, Light Green SF Yellowish, Malachite Green Oxalate, Metanil Yellow, Methylene Blue, Methylene Blue Chloride, Methylene Green, Methyl Green, Methyl Green Zinc Chloride Salt, Methyl Orange Reagent A.C.S., Methyl Violet 2B, Morin, Naphthol Green B, Neutral Red, New Fuchsin, New Methylene Blue N, Nigrosin Water Soluble, Nigrosin B Alcohol Soluble, Nile Blue A, Nuclear Fast Red, Oil Red O, Orange II, Orange IV, Orange G, Patent Blue, 4-(Phenylazo)-1-naphthalenamine Hydrochloride, Phloxine B, Ponceau G R 2R, Ponceau 3R, Ponceau S, Procion Blue HB, Prussian Blue, Pyronin B, Pyronin Y, Quinoline Yellow SS, Rhodamine 6G, Rhodamine B Base Alcohol Soluble, Rhodamine B O, p-Rosaniline Acetate Powder, Rose Bengal, Rosolic Acid, Saffron, Safranine O, Stilbene Yellow, Sudan I, Sudan II, Sudan III, Sudan IV, Sudan Black B, Sudan Orange G, Tartrazine, Thioflavine T TG, Thionin, Toluidine Blue O, Tropaeolin O, Trypan Blue, Ultramarine Blue, Victoria Blue B, Victoria Blue R, Xylene Cyanol FF, Xylene Cyanol FF, Alizarin, Alizarin carmine (for staining bone), Alizarin red S (sodium monosulfonate) monohydrate, Alum carmine, Amaranth, Arsenazo III, Basic red 2 (Cotton red; Gossypimine; Safranin A or O or Y), Bismark brown, Bromocresol green, Bromocresol purple, Bromophenol blue, sodium salt, Bromophenol red, Bromothymol blue, Calcein, Calcon (Eriochrome black B), Clayton yellow (Thiazole yellow), Coomassie blue (Brilliant blue), Cotton Red (Basic red 2; Gossypimine; Safranin A or O or Y), Cresol red sodium salt, Cupferron, 2′,7′-Dichloro fluorescein, Dicyanobis (1,10-phenanthroline)Iron, Diethyldithiocarbamic acid silver salt, 4,7-Diphenyl-1,10-phenanthroline-x.x-disulfonic acid diNa salt, Diphenylthiocarbazone, Dithizone, Eosin bluish, Eosin Y, Eriochrome black B (Calcon), Eriochrome black T, Eriochrome blue, Eriochrome blue black R, Eriochrome blue SE, Eriochrome gray SGL, Eriochrome red B, Erionglaucine (A), Erythrosin B, Fast Green FCF, Fuchsin acid, Fuchsin basic (Pararosaniline HCI), Gentian Violet, Gossypimine (Basic red 2; Cotton red; Safranin A or O or Y), Hematoxylin, Hydroxy Naphthol blue, Indigo blue pigment, Janus green B, Methyl orange, Methyl red, Methyl thymol blue, Methyl violet B (Aniline violet; Dahlia violet B), Methyl violet base (Solvent violet 8), Methylene blue, Murexide indicator, Neutral red, Orange G, Orange IV, Owen's blue, Patent blue (Acid blue 1), Pararosaniline HCI (Basic fuchsin), Phenolphthalein, Phenol red, Phlorglucinol dihydrate, Pyronine Y (or G), Safranin, Safranin A or O or Y (Basic red 2; Cotton red; Gossypimine), Solvent violet 8 (Methyl violet base), Sudan III, Sudan IV, Thiazole yellow (Clayton yellow), Thymol blue, Thymolphthalein pH indicator 9.4-10.6, Wright's stain, Xylene cyanole FF, Chromotrope 2B, Chromotrop 2R, Clayton Yellow; Cochineal Red A, Congo Red, Coomassie® Brilliant Blue G-250, Coomassie® Brilliant Blue R-250, Cotton Blue, Crocein Scarlet 3B, Curcumin, Diazo Blue B, Eosin B, Eosin B Water Soluble, Eosin Y, Eriochrome Black A, Eriochrome Black T Reagent A.C.S., Eriochrome Blue Black R, Eriochrome Cyanine R, Erioglaucine, Erythrosin B, Ethyl Eosin, Ethyl Violet, Evans Blue, Fast Garnet GBC Base, Fast Garnet GBC Salt, Fast Green FCF, Fluorescein Alcohol Soluble U.S.P., Fluorescein Alcohol Soluble, Fluorescein Water Soluble, Hematoxylin, 8-Hydroxy-136-pyrenetrisulfonic Acid trisodium Salt; Indigo Synthetic, Indigo Carmine, Indophenol Blue, Indulin Water Soluble, and Janus Green B.

20. The method of claim 1, wherein the step of imaging cells comprises imaging at least 50 cells per image.

21. The method of claim 1, wherein the step of imaging cells comprises imaging at least 100 cells per image.

22. The method of claim 1, wherein the step of imaging cells comprises imaging at least 200 cells per image.

23. The method of claim 1, wherein the characteristic is selected from the groups consisting of eccentricity of cells, average number of nuclei per cell, average area of cells, average volume of cells, average number of centromeres per cell, average size of nuclei, average area of nuclei, average size of cells, perimeter of cell, perimeter of nucleus, average gray value of staining, and morphology.

24. A method of screening, the method comprising steps of:
providing a plurality of cell samples;
providing a plurality of test agents;
contacting one of the cell samples with one of the test agents;
imaging the plurality of cell samples after a time period;
analyzing the images of the cell samples for various characteristics; and
selecting those test agents that achieve a certain characteristic of the cells upon exposure of the cells to the test agent.

25. The method of claim 24, wherein the plurality of cell samples comprises greater than 100 cell samples.

26. The method of claim 24, wherein the plurality of cell samples comprises greater than 1000 cell samples.

27. The method of claim 24, wherein the plurality of cell samples comprises greater than 5000 cell samples.

28. The method of claim 24, wherein the plurality of cell samples comprises greater than 10,000 cell samples.

29. A system for carrying out the method of claim 1.

30. The system of claim 29 comprising an optical unit, a unit for digitizing the image, and a microprocessor running software designed to carry out the image analysis of cells.
